(19) United States
(12) Patent Application Publication
(10) Pub. No.: US 2025/0130694 A1
(43) Pub. Date: Apr. 24, 2025

(54) CUSTOMIZED DATA MANAGEMENT BASED ON DATABASE ANALYTICS

(71) Applicant: SuprWorks, LLC, Tampa, FL (US)

(72) Inventors: Jesus Vega, Avon Lake, OH (US); Jeffrey Henry, Shenandoah, TX (US)

(21) Appl. No.: 18/921,632

(22) Filed: Oct. 21, 2024

Related U.S. Application Data
(60) Provisional application No. 63/592,764, filed on Oct. 24, 2023.

(51) Int. Cl. G06F 3/0482; G06F 3/04817

(52) U.S. Cl. CPC G06F 3/0482; G06F 3/04817

(57) ABSTRACT

In certain aspects, a computer-implemented method includes creating lead profiles based on lead information. The method includes generating a pipeline, wherein the pipeline comprises staged actions. The method includes assigning a lead profile of the lead profiles created to the pipeline. The method includes generating a campaign associated with the pipeline. The method includes initiating tasks in response to status levels of the pipeline comprising the staged actions being monitored. The method includes customizing a graphical user interface dashboard for displaying metrics associated with the staged actions being monitored and based on the status levels of the pipeline comprising the staged actions.

### CROSS-REFERENCE TO RELATED APPLICATION

The present application claims the benefit of priority under 35 U.S.C. § 119 from U.S. Provisional Patent Application Ser. No. 63/592,764 entitled “Customized Data Management Based on Database Analytics,” filed on Oct. 24, 2023, the disclosure of which is hereby incorporated by reference in its entirety for all purposes.

### TECHNICAL FIELD

The present disclosure generally relates to database analytics, and more specifically relates to customized data management based on database analytics.

### BACKGROUND

Organizations rely on data management to drive business decisions, but may be overwhelmed by the amount of accessible data. While conventional tools are available for organizations to manage such data, there is still a desire for managing data in a more efficient and effective manner.

The description provided in the background section should not be assumed to be prior art merely because it is mentioned in or associated with the background section. The background section may include information that describes one or more aspects of the subject technology.

### SUMMARY

According to certain aspects of the present disclosure, a computer-implemented method for customizing data management based on database analytics is provided. The method includes creating lead profiles based on lead information. The method includes generating a pipeline, wherein the pipeline comprises staged actions. The method includes assigning a lead profile of the lead profiles created to the pipeline. The method includes generating a campaign associated with the pipeline. The method includes initiating tasks in response to status levels of the pipeline comprising the staged actions being monitored. The method includes customizing a graphical user interface dashboard for displaying metrics associated with the staged actions being monitored and based on the status levels of the pipeline comprising the staged actions.

According to certain other aspects of the present disclosure, a system is provided. The system includes a memory comprising instructions and a processor configured to execute the instructions which, when executed, cause the processor to create lead profiles based on lead information. The processor is configured to execute the instructions which, when executed, cause the processor to generate a pipeline, wherein the pipeline comprises staged actions. The processor is configured to execute the instructions which, when executed, cause the processor to assign a lead profile of the lead profiles created to the pipeline. The processor is configured to execute the instructions which, when executed, cause the processor to generate a campaign associated with the pipeline. The processor is configured to execute the instructions which, when executed, cause the processor to initiate tasks in response to status levels of the pipeline comprising the staged actions being monitored. The processor is configured to execute the instructions which, when executed, cause the processor to customize a graphical user interface dashboard for displaying metrics associated with the staged actions being monitored and based on the status levels of the pipeline comprising the staged actions.

According to certain other aspects of the present disclosure, a non-transitory machine-readable storage medium comprising machine-readable instructions for causing a processor to execute a method is provided. The method includes creating lead profiles based on lead information. The method includes generating a pipeline, wherein the pipeline comprises staged actions. The method includes assigning a lead profile of the lead profiles created to the pipeline. The method includes generating a campaign associated with the pipeline. The method includes initiating tasks in response to status levels of the pipeline comprising the staged actions being monitored. The method includes customizing a graphical user interface dashboard for displaying metrics associated with the staged actions being monitored and based on the status levels of the pipeline comprising the staged actions.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for customizing data management based on database analytics, according to certain aspects of the disclosure.

FIG. 2 is a block diagram illustrating the example management service, at least one computing device, at least one vendor service, and database from FIG. 1, according to certain aspects of the disclosure.

FIGS. 3 illustrates an example process for customizing data management based on database analytics using the example management service, at least one computing device, at least one vendor service, and database of FIG. 2, according to certain aspects of the disclosure.

FIGS. 4A-4JJ are example illustrations associated with example processes according to certain aspects of the disclosure.

FIG. 5 is a block diagram illustrating an example computer system with which the management service, at least one computing device, at least one vendor service, and database of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

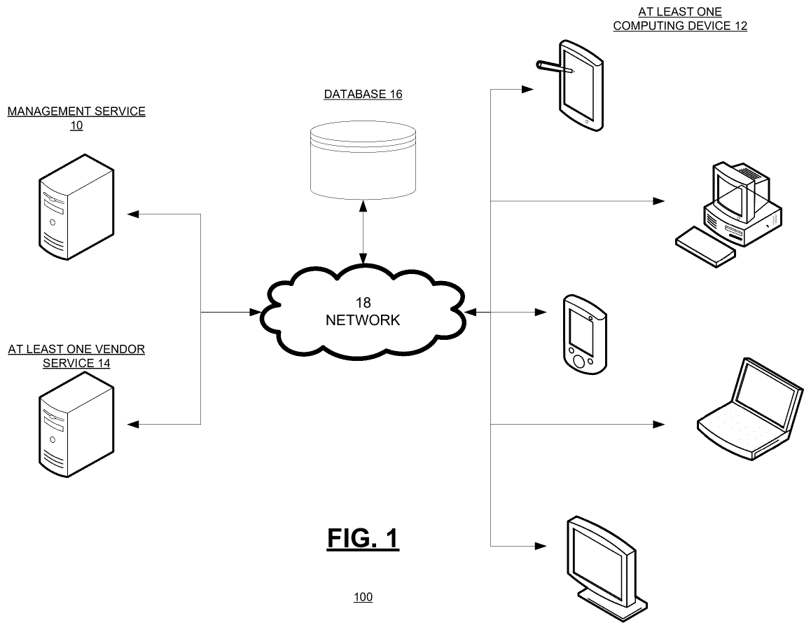

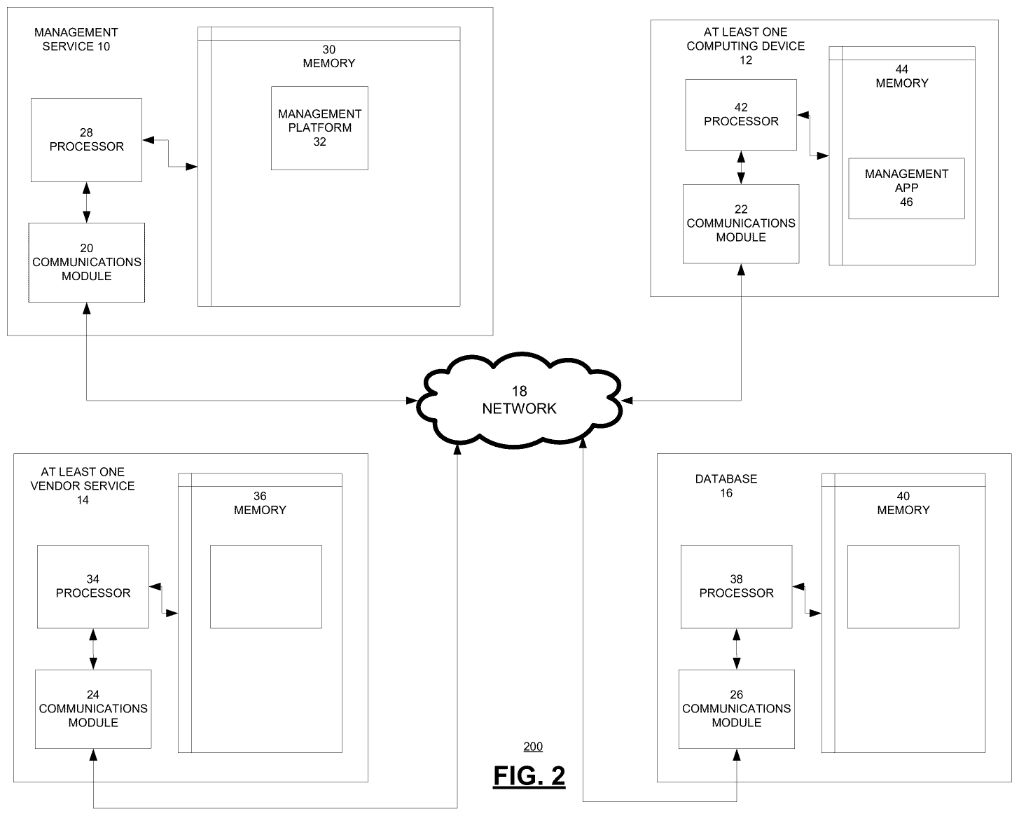

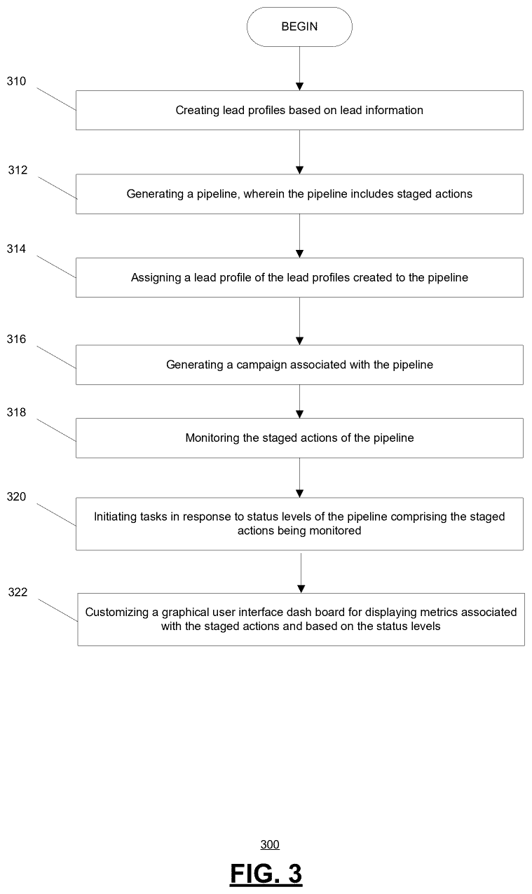

FIG. 1 illustrates an example architecture 100 for customizing data management based on database analytics. The architecture 100 includes a management service 10, at least one computing device 12, at least one vendor service 14, and a database 16, connected over a network 18.

The management service 10 can be any device having an appropriate processor, memory, and communications capability for communicating with the at least one computing device 12, the at least one vendor service 14, and the database 16. For purposes of load balancing, the management service 10 may include multiple servers. The at least one vendor service 14 can be any device having an appropriate processor, memory, and communications capability for communicating with the management service 10, the at least one vendor service 14, and the database 16. The database 16 can be any device having an appropriate processor, memory, and communications capability for communicating with the management service 10, the at least one computing device 12, and the at least one vendor service 14. For purposes of load balancing, the database 16 may include multiple servers. The at least one computing device 12, to which the management service 10 communicates with over the network 18, can be any endpoint device, for example, a tablet computer, a mobile phone, a mobile computer, a laptop computer, a portable media player, an electronic book (eBook) reader, a desktop computer, or any other device having appropriate processor, memory, and communications capabilities. In certain aspects, the management service 10 and the at least one vendor service 14 can be a cloud computing server of an infrastructure-as-a-service (IaaS) and be able to support a platform-as-a-service (PaaS) and software-as-a-service (SaaS) services.

The network 18 can include, for example, any one or more of a personal area network (PAN), a local area network (LAN), a campus area network (CAN), a metropolitan area network (MAN), a wide area network (WAN), a broadband network (BBN), the Internet, and the like. Further, the network 18 can include, but is not limited to, any one or more of the following network topologies, including a bus network, a star network, a ring network, a mesh network, a star-bus network, tree or hierarchical network, and the like.

FIG. 2 is a block diagram illustrating examples of the management service 10, the at least one computing device 12, the at least one vendor service 14, and the database 16 in the architecture 100 of FIG. 1 according to certain aspects of the disclosure.

The management service 10, the at least one computing device 12, the at least one vendor service 14, and the database 16 are connected over the network 18 via respective communication modules 20, 22, 24, 26. The communications modules 20, 22, 24, 26 are configured to interface with the network 18 to send and receive information, such as data, requests, responses, and commands to other devices on the network 18. The communications modules 20, 22, 24, 26 can be, for example, modems or Ethernet cards.

The management service 10 includes a processor 28, the communications module 20, and a memory 30 that includes a management platform 32. The processor 28 of the management service 10 is configured to execute instructions, such as instructions physically coded into the processor 28, instructions received from software in the memory 30, or a combination of both. For example, the processor 28 of the management service 10 executes instructions from the management platform 32 causing the processor 28 to perform functions. The processor 28 of the management service 10 is configured to create lead profiles 48 (e.g., opportunity profiles) associated with the opportunity(s) 92 and based on corresponding lead information 50 such as, but not limited to, the contact information 101 and the opportunity information 102 both associated with the opportunity(s) 92. The processor 28 of the management service 10 is configured to generate a pipeline 52, which includes staged actions 54. The processor 28 of the management service 10 is configured to assign a lead or opportunity profile of the lead profiles 48 to the pipeline 52. The processor 28 of the management service 10 is configured to generate a campaign 56 associated with the pipeline 52. The campaign 56 can be chosen from, but not limited to, the email campaign 130, the SMS campaign 148, and other appropriate campaigns. The processor 28 of the management service 10 is configured to monitor the staged actions 54 of the pipeline 52. The processor 28 of the management service 10 is configured to initiate tasks 58 in response to status levels 60 of the staged actions 54 being monitored. The processor 28 of the management service 10 is configured to customize, responsive to user input, a dashboard graphical user interface (GUI) 62 for displaying metrics 64 associated with at least the staged actions 54 and based on the status levels 60.

The at least one vendor service 14 includes a processor 34, the communications module 24, and a memory 36. The processor 34 of the at least one vendor service 14 is configured to execute instructions, such as instructions physically coded into the processor 34, instructions received from software in the memory 36, or a combination of both. For example, the processor 34 of the at least one vendor service 14 executes instructions causing the processor 38 to perform functions.

The database 16 includes a processor 38, the communications module 26, and a memory 40. The processor 38 of the database 16 is configured to execute instructions, such as instructions physically coded into the processor 38, instructions received from software in the memory 40, or a combination of both. For example, the processor 38 of the database executes instructions causing the processor 38 to perform functions.

The at least one computing device 12 includes a processor 42, the communications module 22, and a memory 44 that includes a management app 46. The processor 42 of the at least one computing device 12 is configured to execute instructions, such as instructions physically coded into the processor 42, instructions received from software in memory 44, or a combination of both. For example, the processor 42 of the at least one computing device 12 executes instructions causing the processor 42 to perform functions.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

FIG. 3 illustrates an example process 300 for customizing data management based on database analytics using the management service 10, the at least one computing device 12, the at least one vendor service 14, and the database 16 of FIG. 2. While FIG. 3 is described with reference to FIG. 2, it should be noted that the process steps of FIG. 3 may be performed by other systems.

The process begins by proceeding to step 310 when the processor 28 of the management service 10 creates lead profiles 48 (e.g., opportunity profiles) associated with the opportunity(s) 92 and based on lead information 50 such as, but not limited to, the contact information 101 and the opportunity information 102 both associated with the opportunity(s) 92. As illustrated at step 312, the processor 28 of the management service 10 generates a pipeline 52, which includes staged actions 54. The processor 28 of the management service 10 assigns a lead or opportunity profile of the lead profiles 48 to the pipeline 52, as depicted at step 314.

The processor 28 of the management service 10 generates a campaign 56 associated with the pipeline 52, as illustrated at step 316. At step 318, the processor 28 of the management service 10 monitors the staged actions 54 of the pipeline 52. The processor 28 of the management service 10 initiates tasks 58 in response to status levels 60 of the pipeline 52 including the staged actions 54 being monitored, as illustrated at step 320. As illustrated at step 322, the processor 28 of the management service 10 customizes, responsive to user input, a dashboard graphical user interface (GUI) 62 for displaying metrics 64 associated with the staged actions 54 and based on the status levels 60.

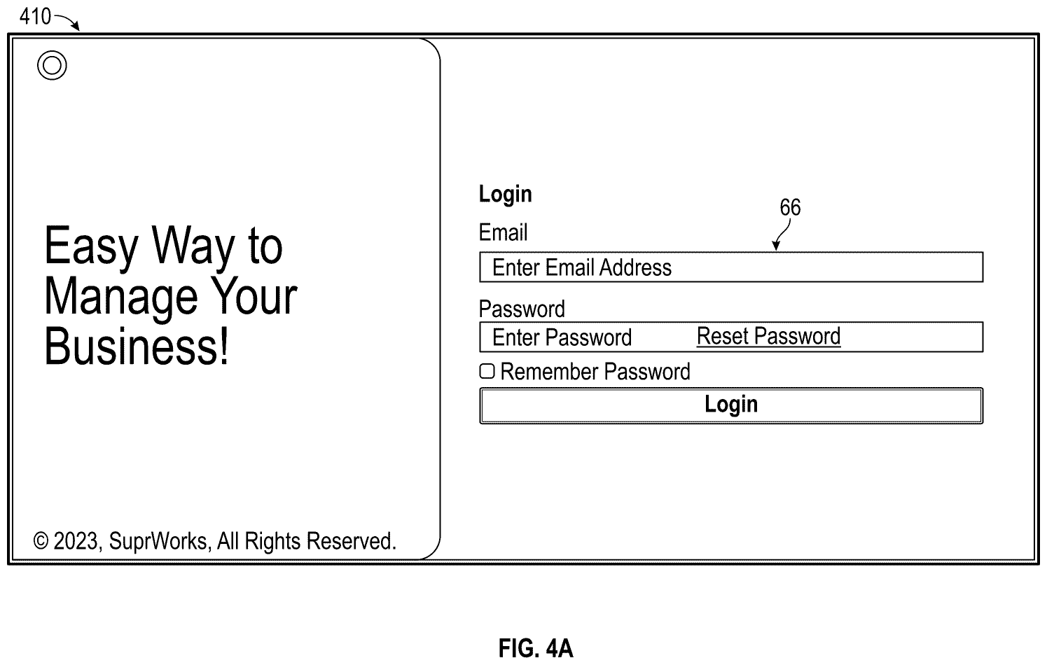

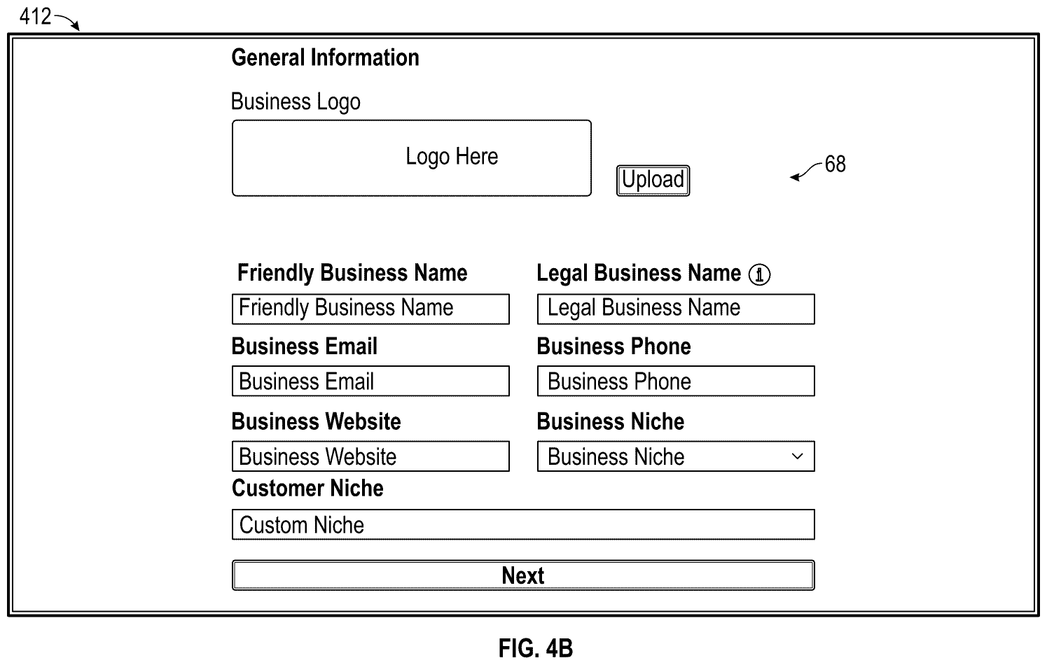

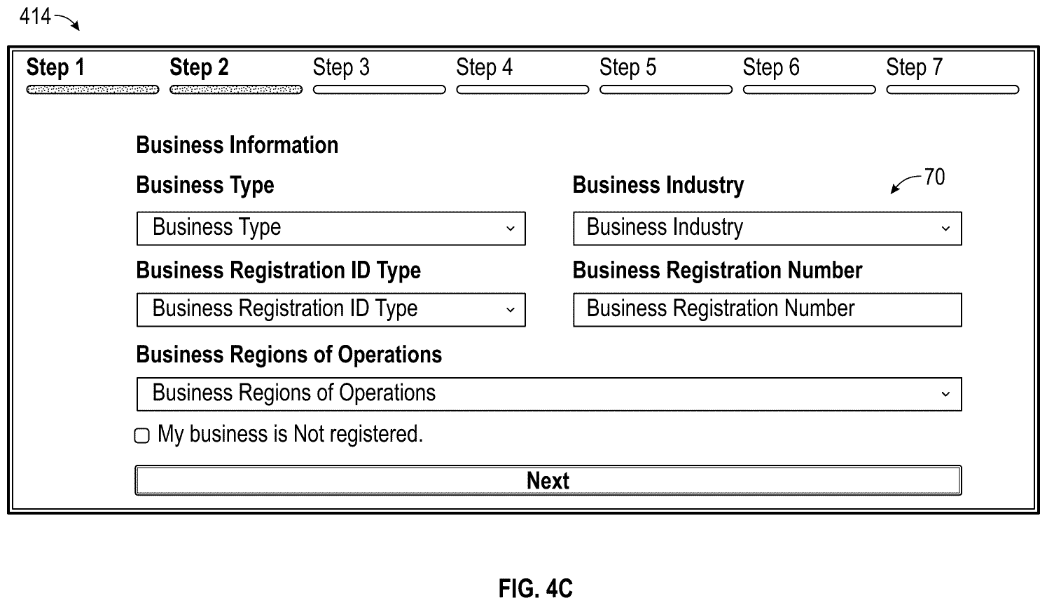

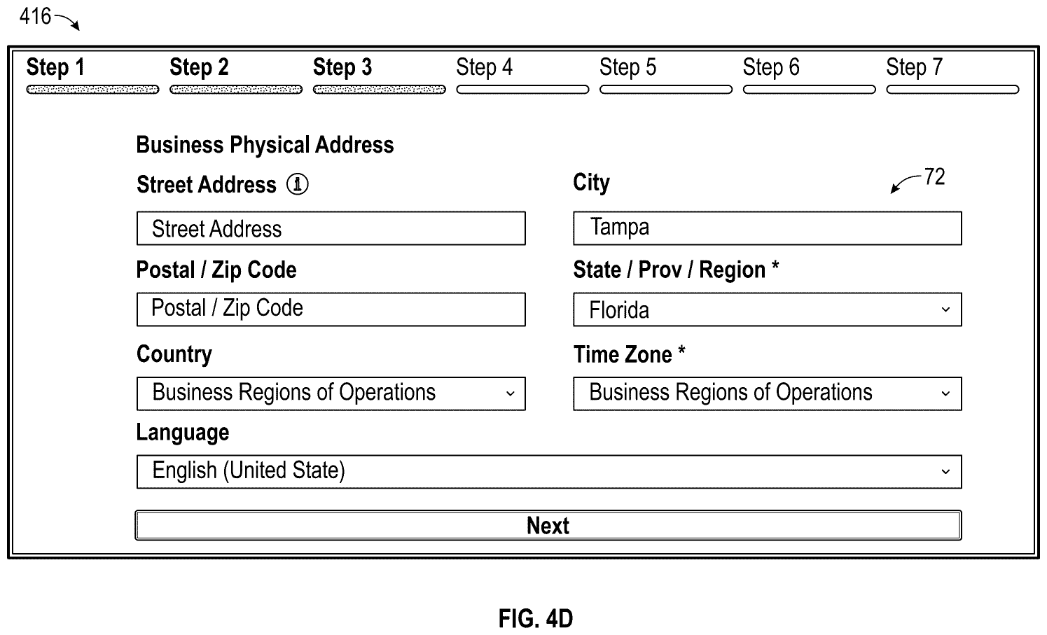

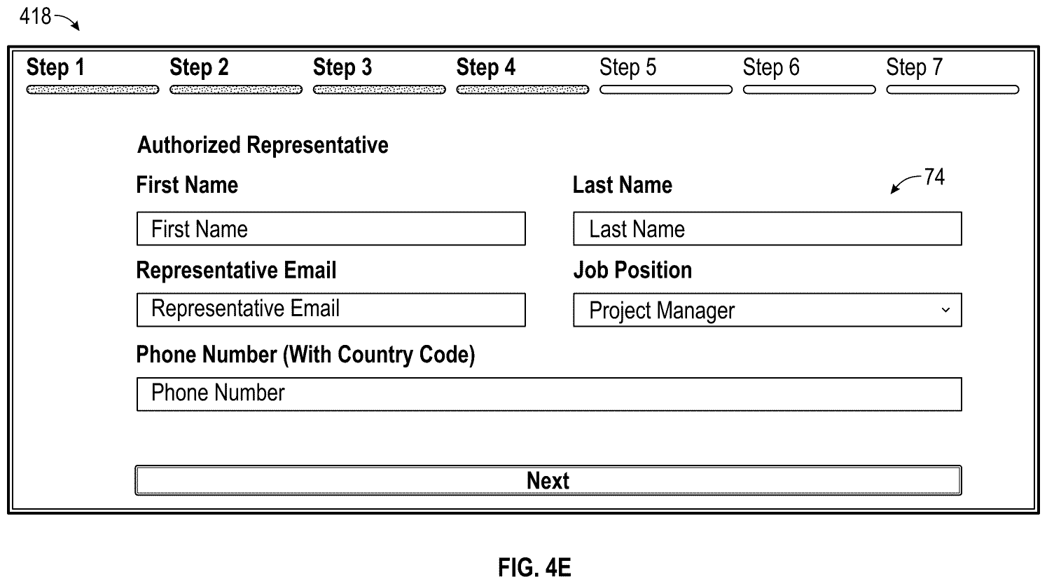

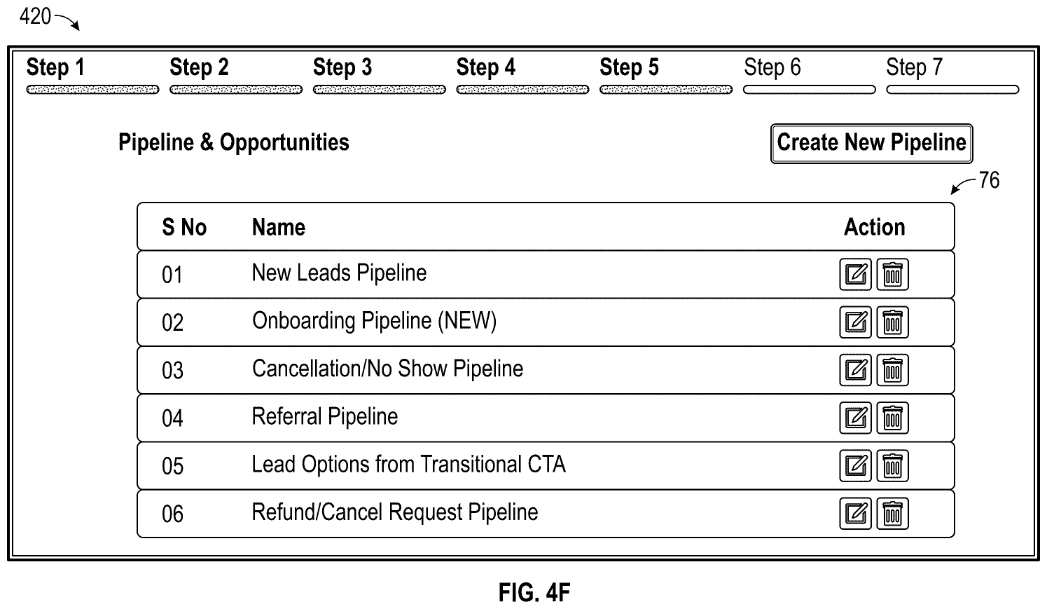

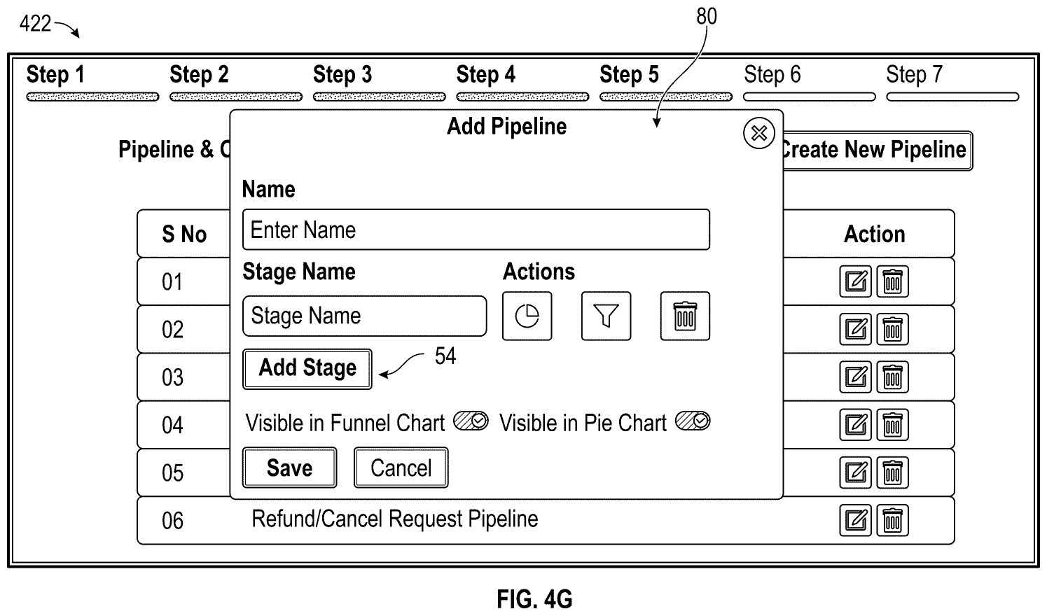

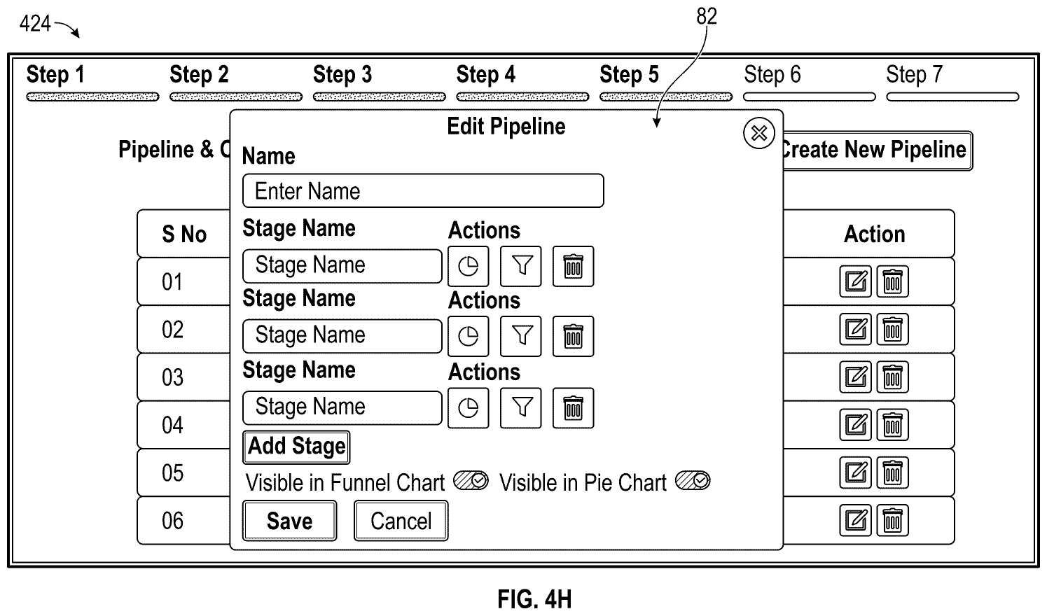

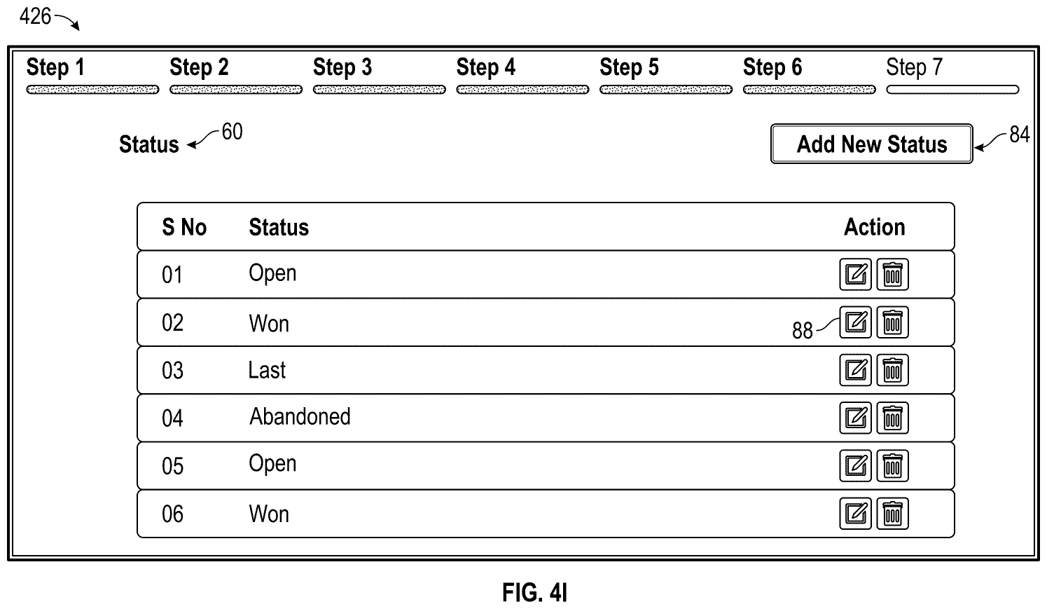

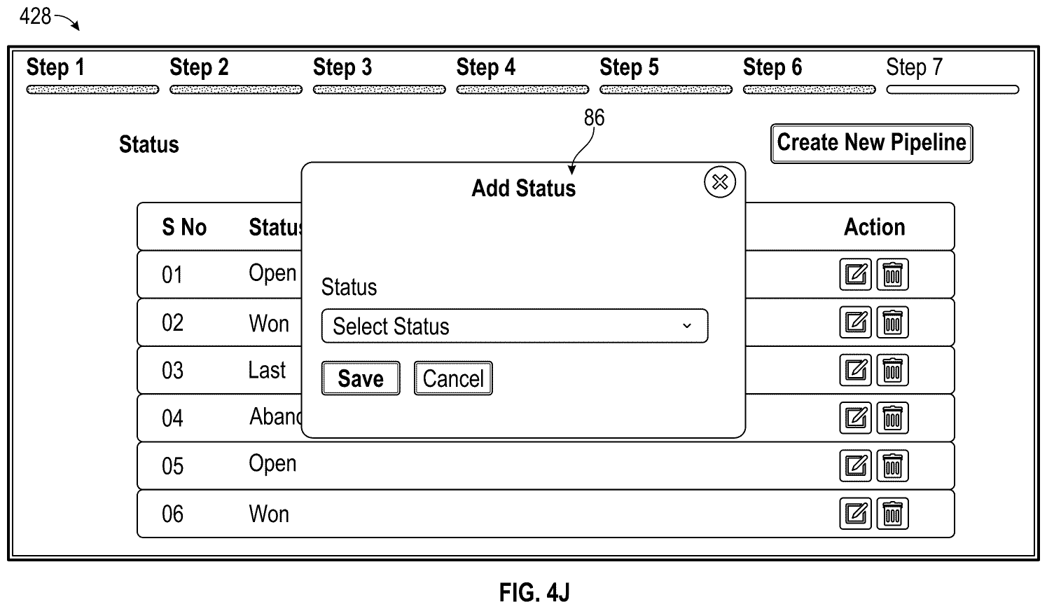

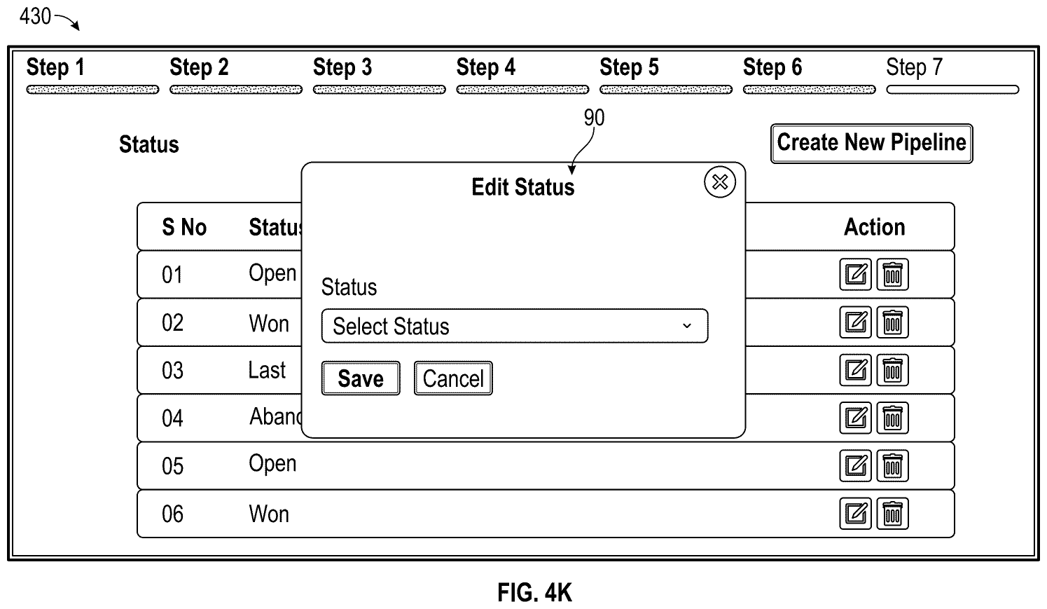

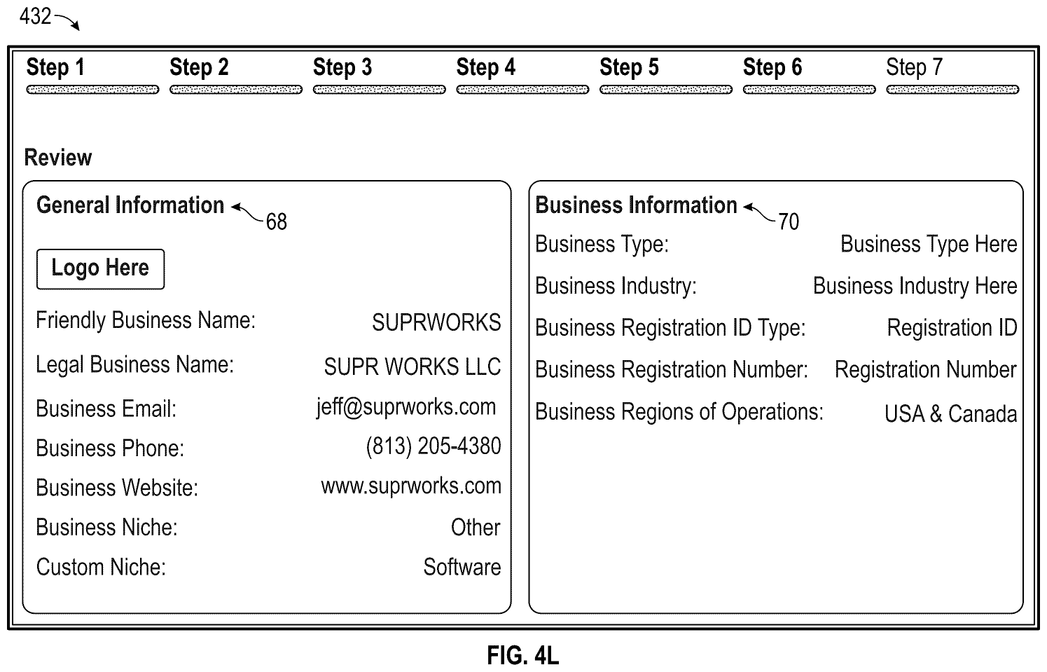

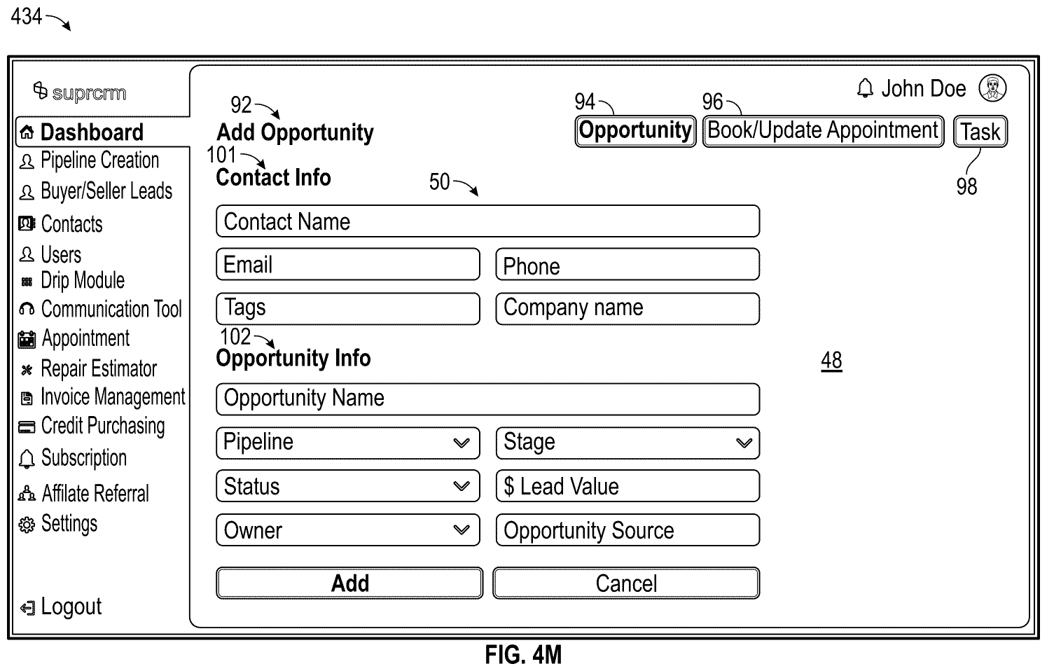

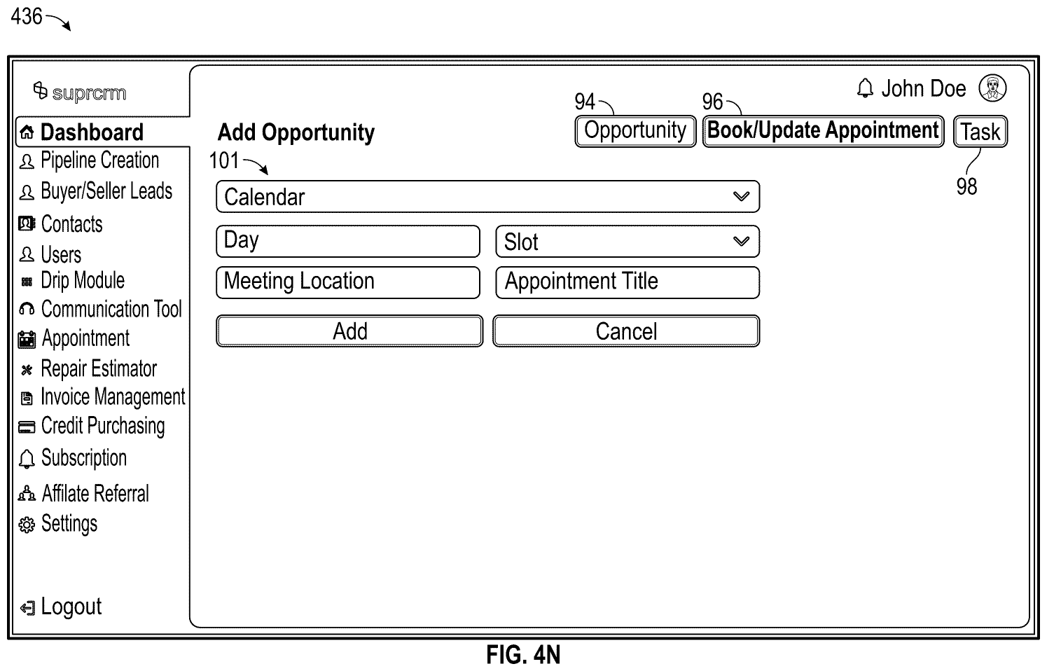

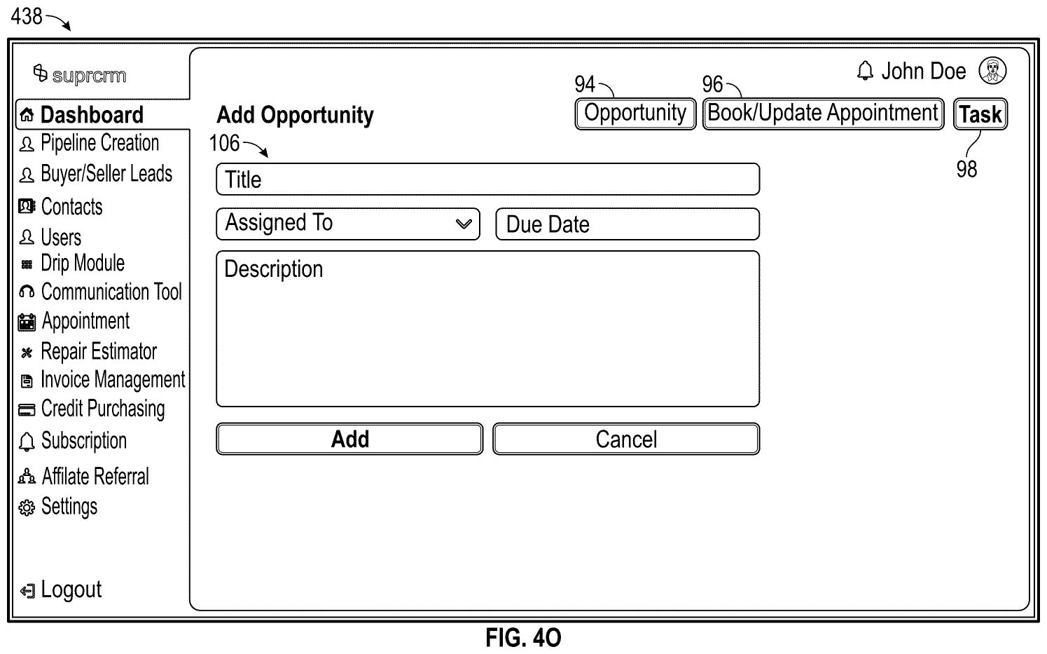

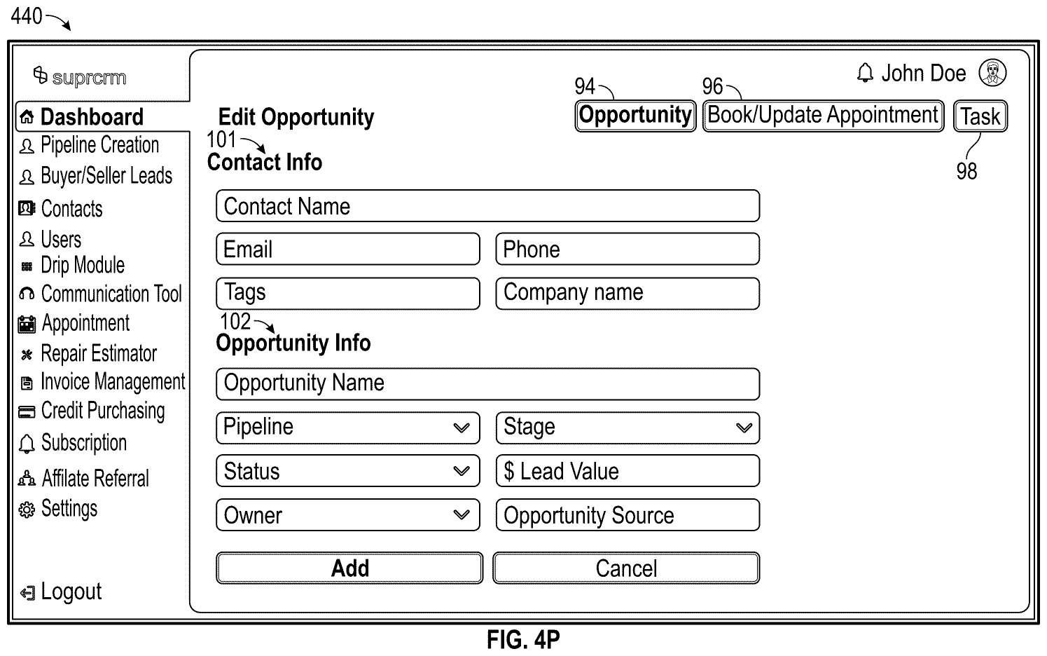

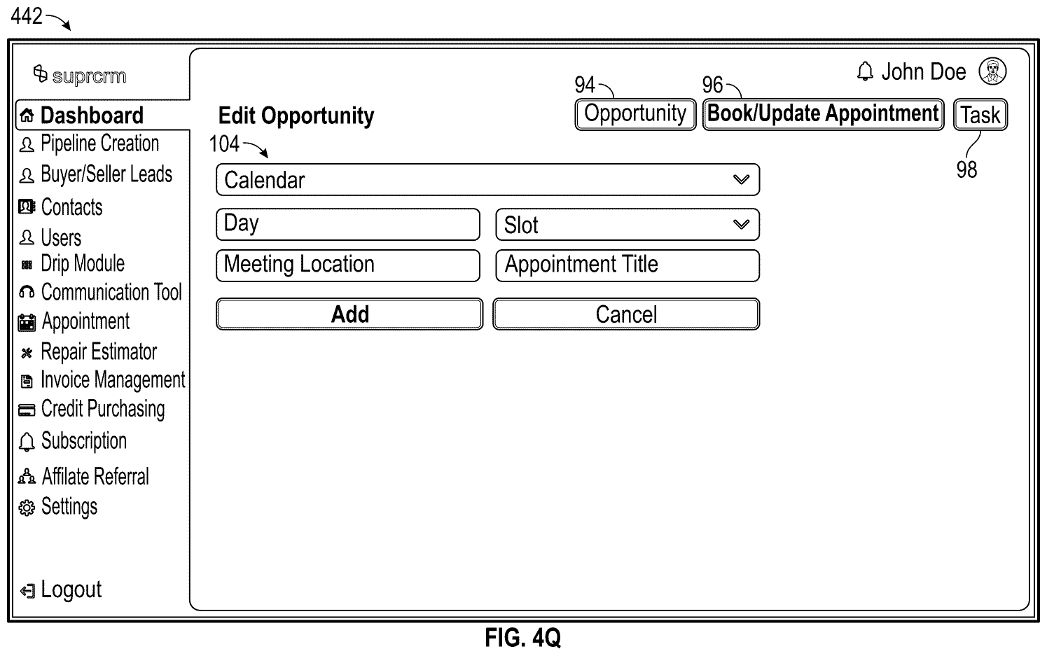

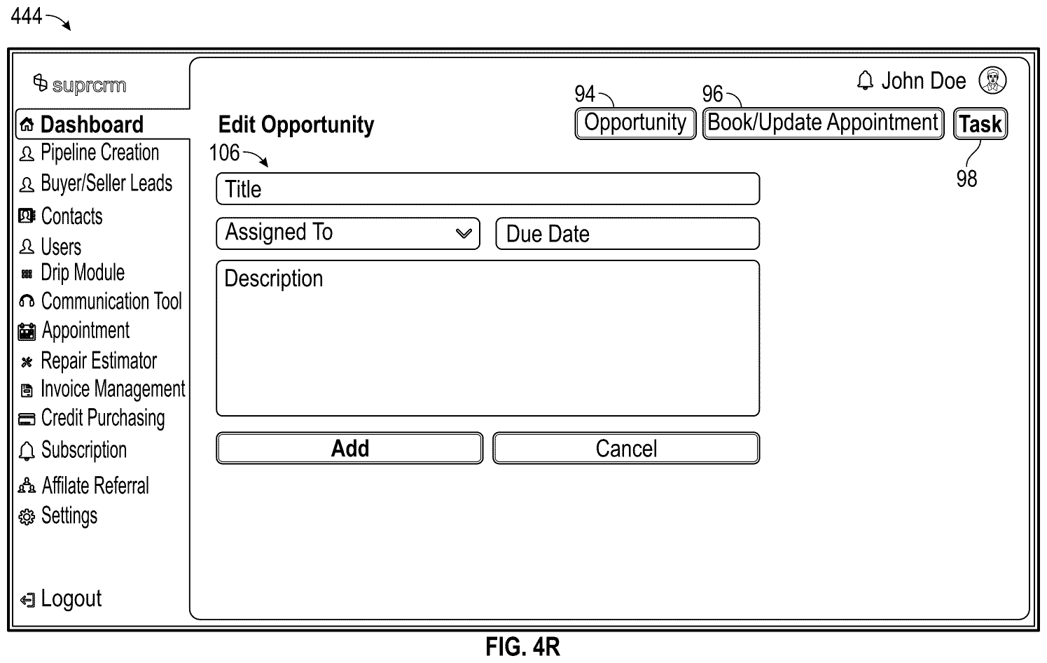

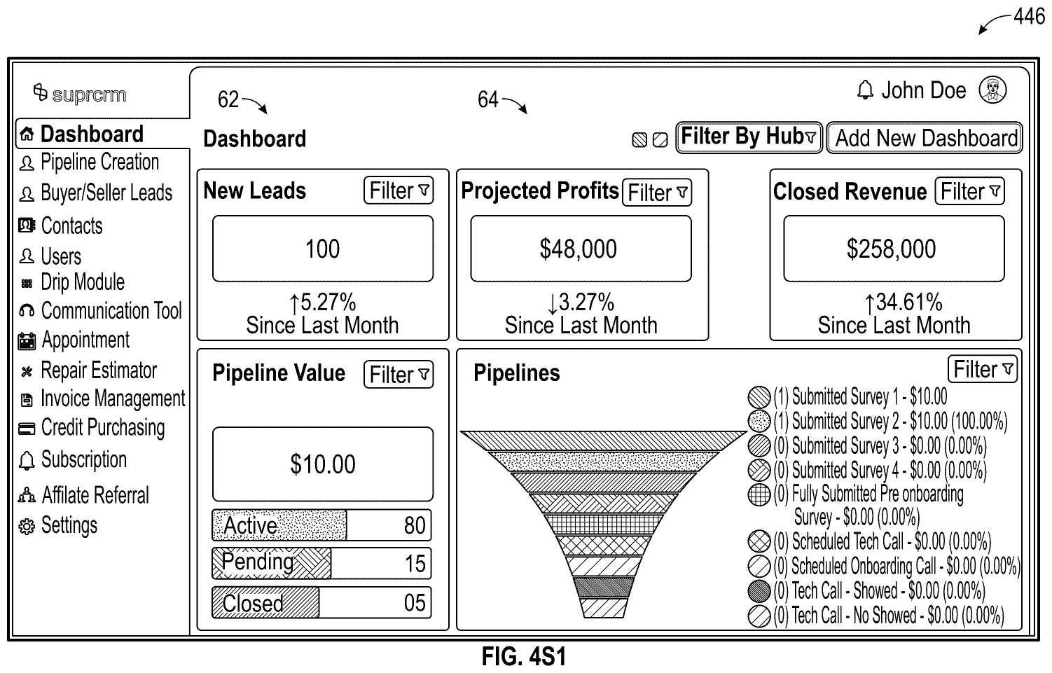

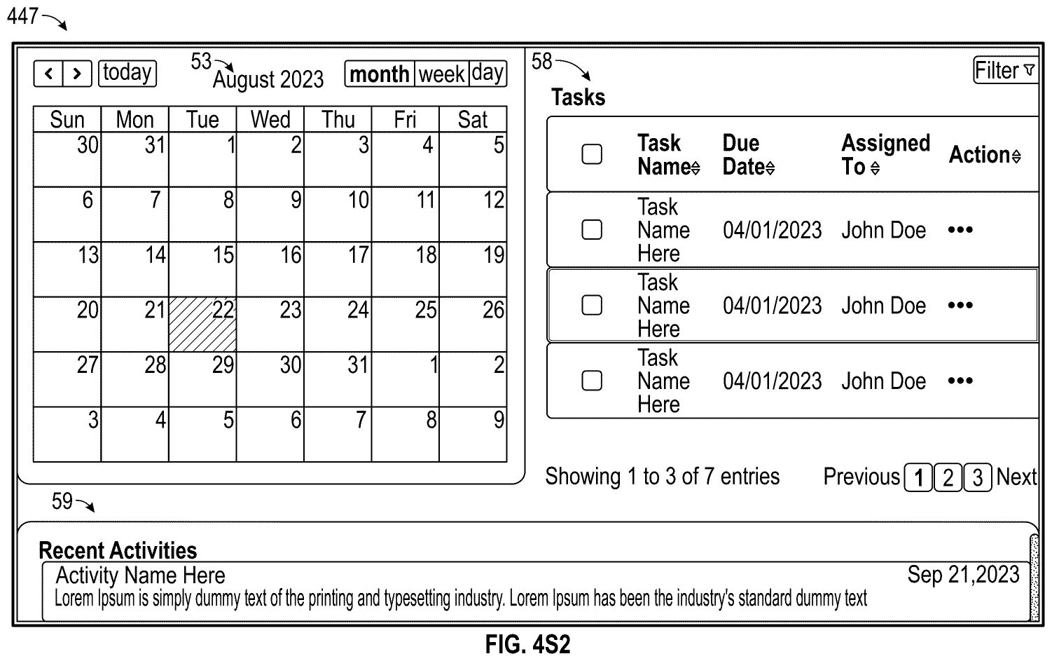

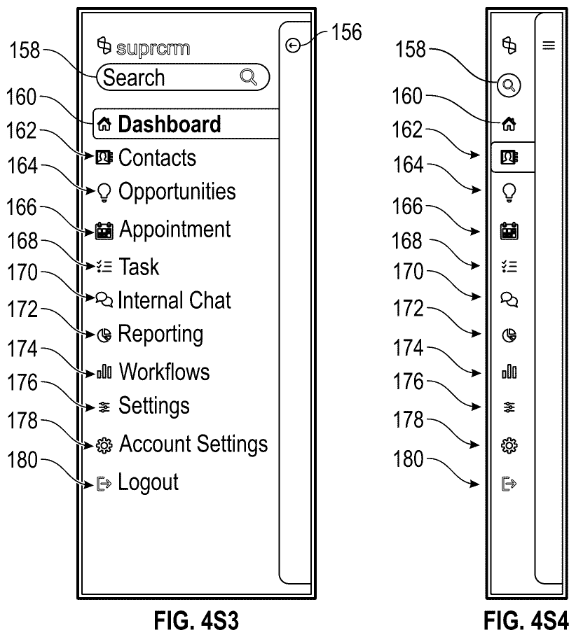

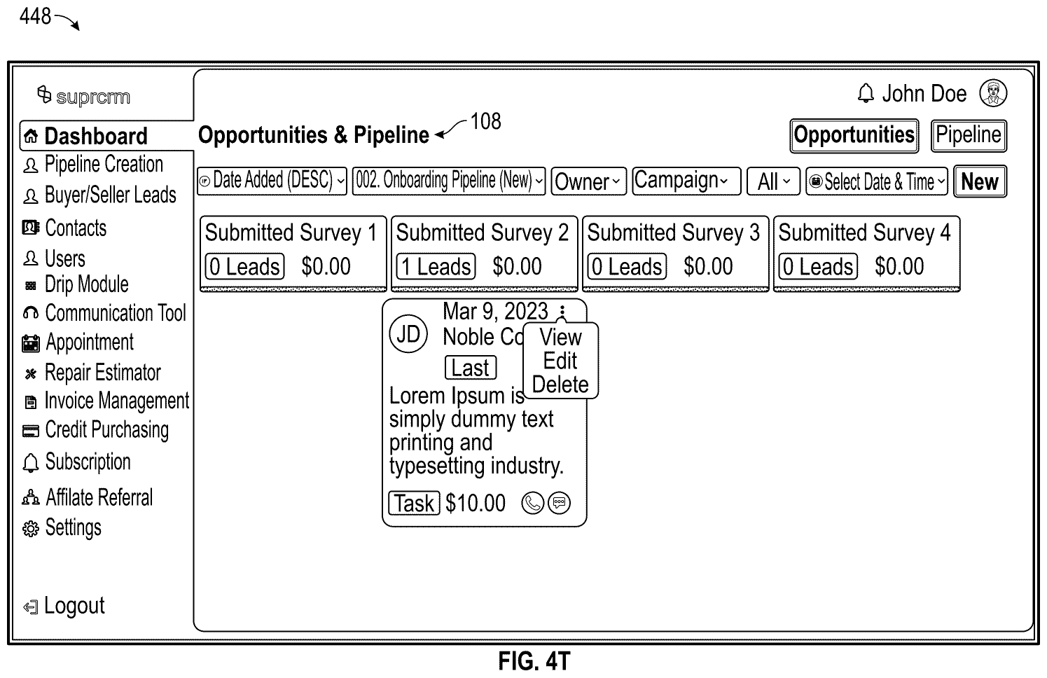

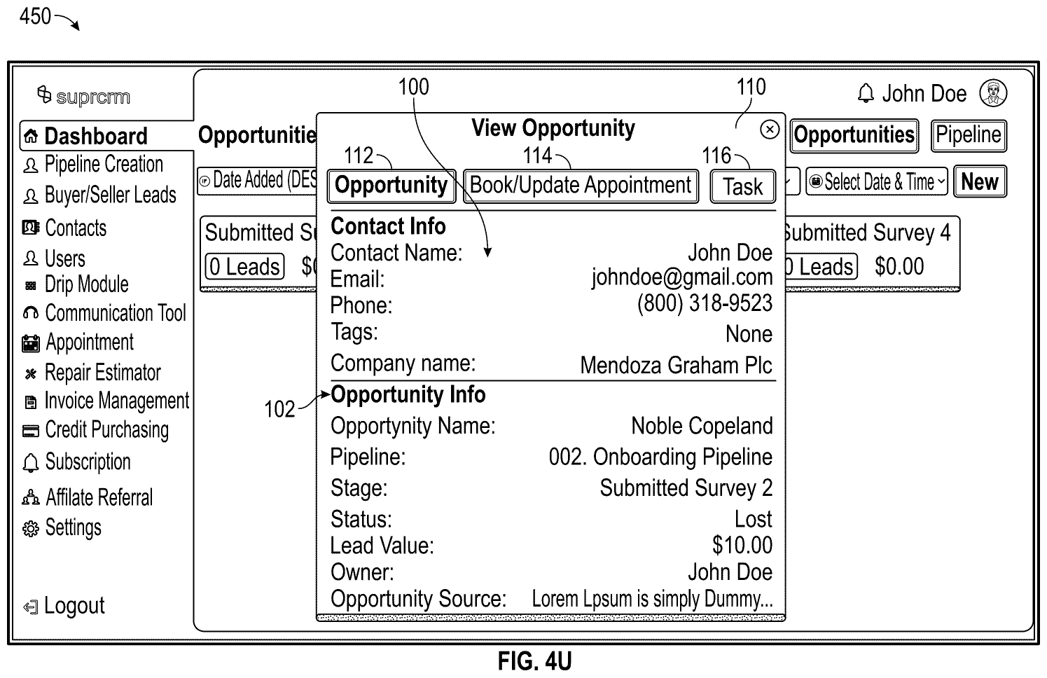

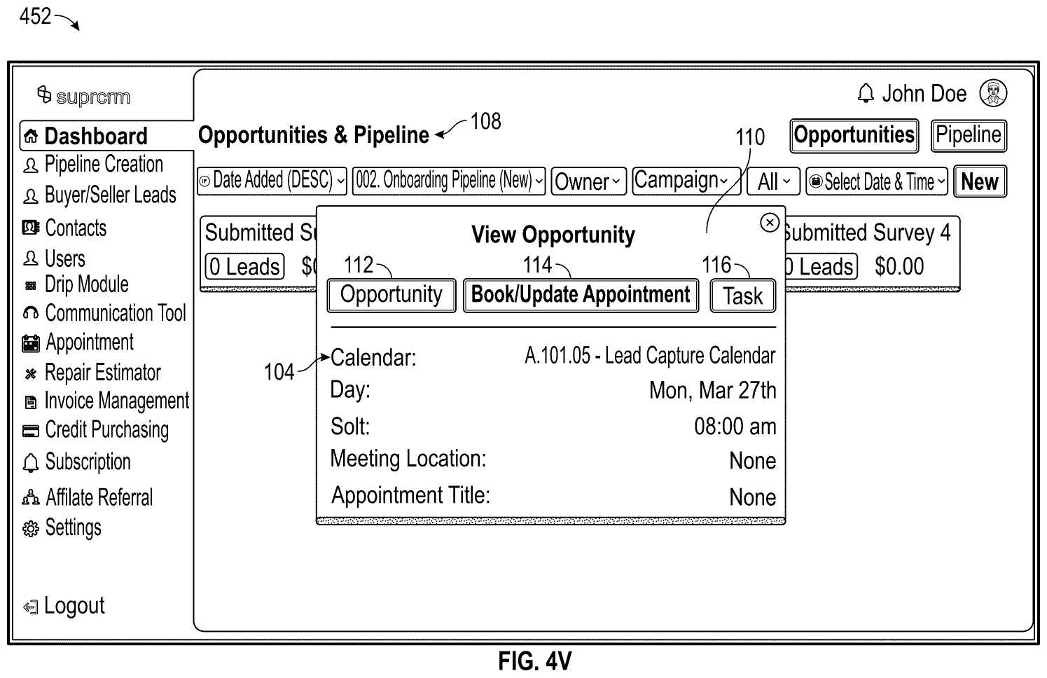

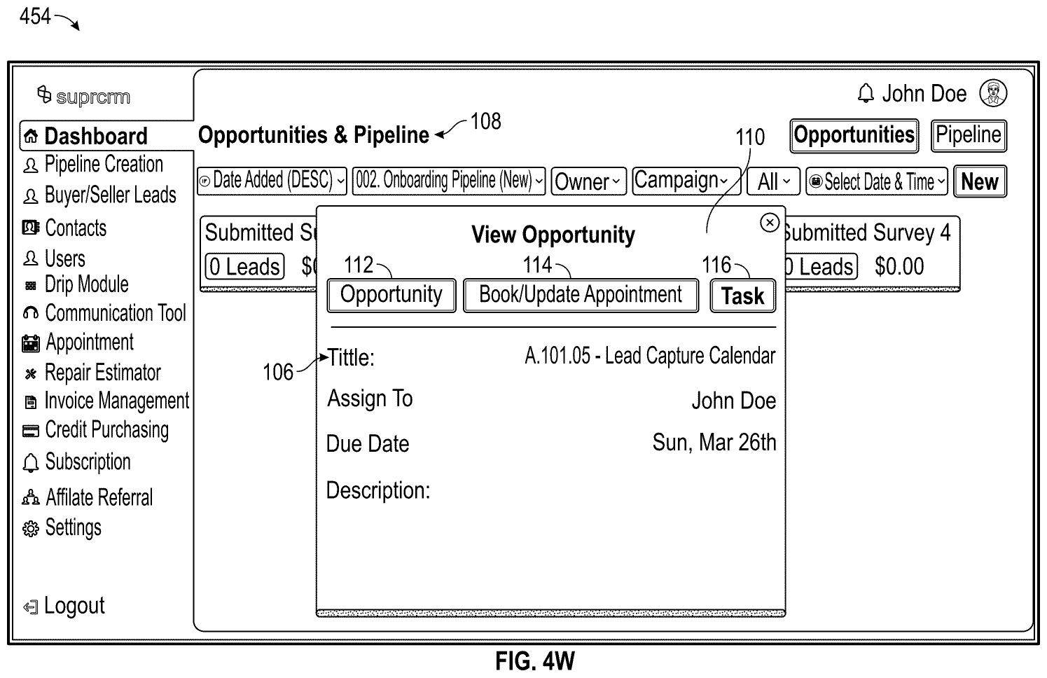

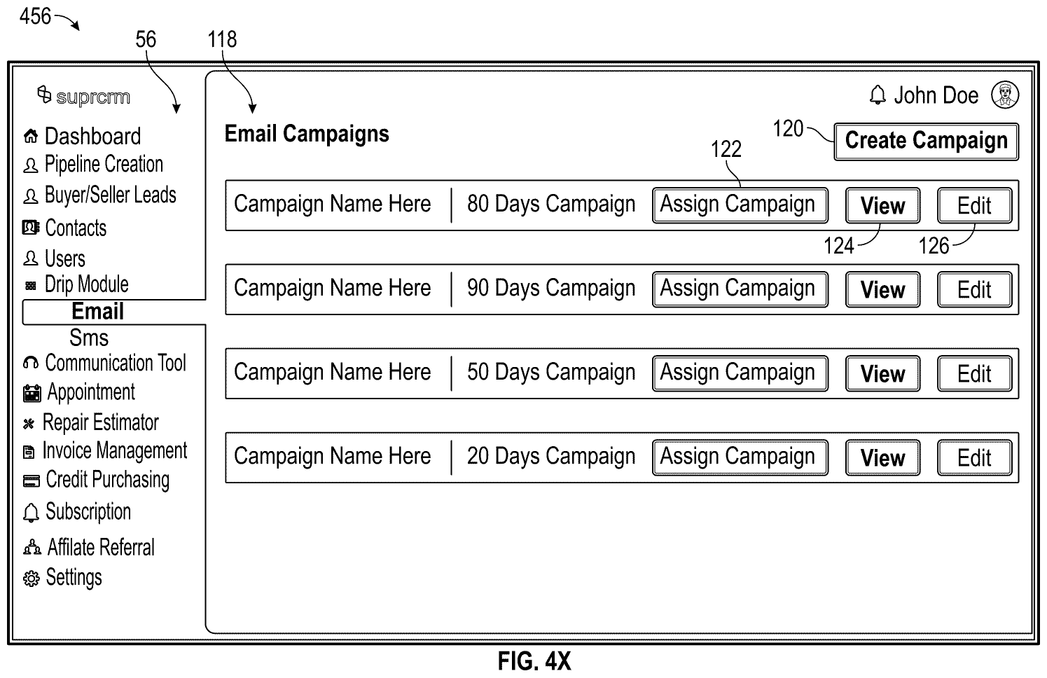

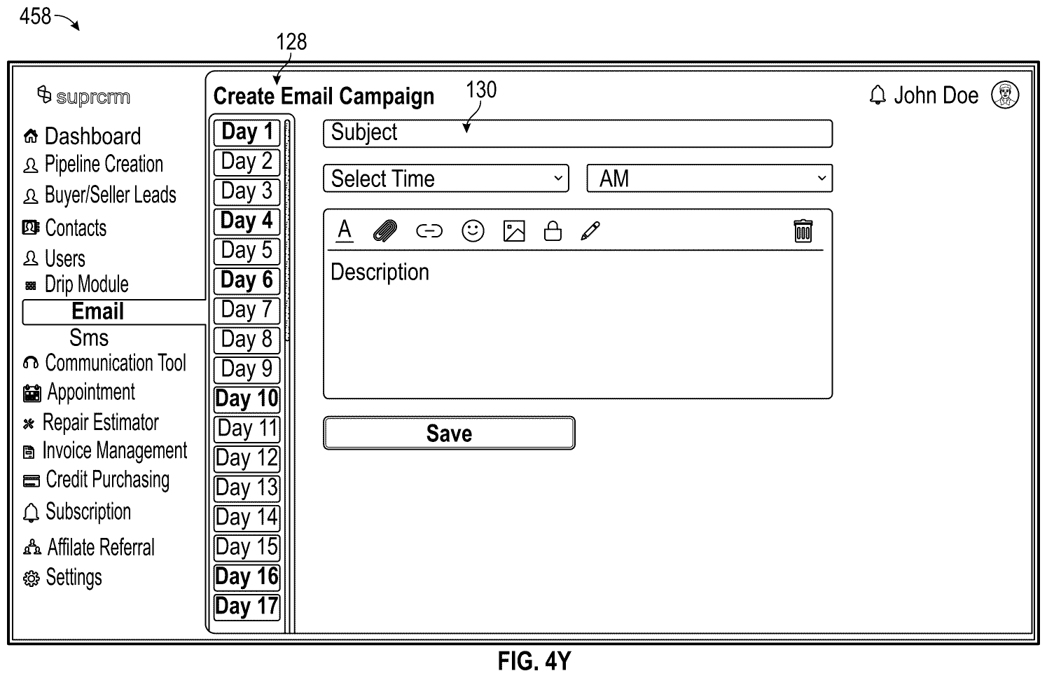

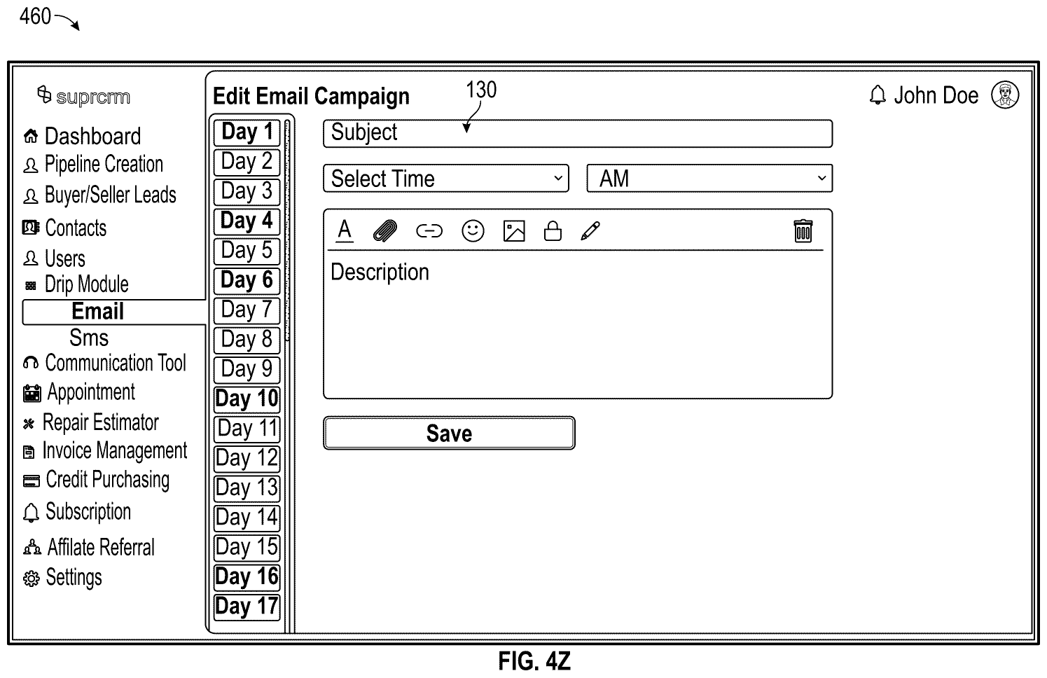

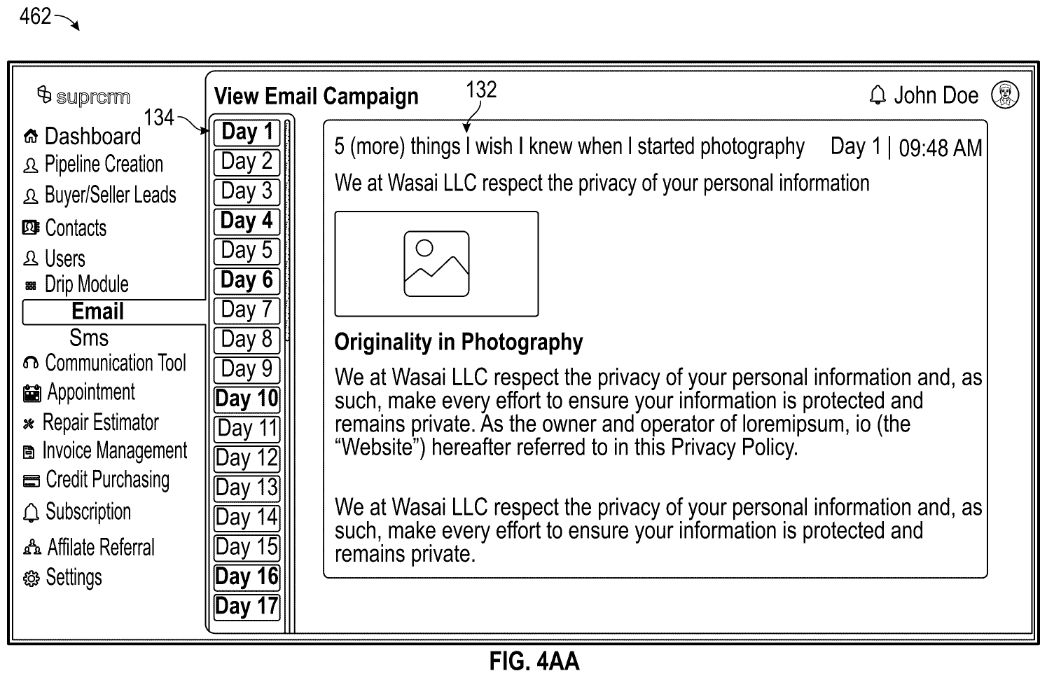

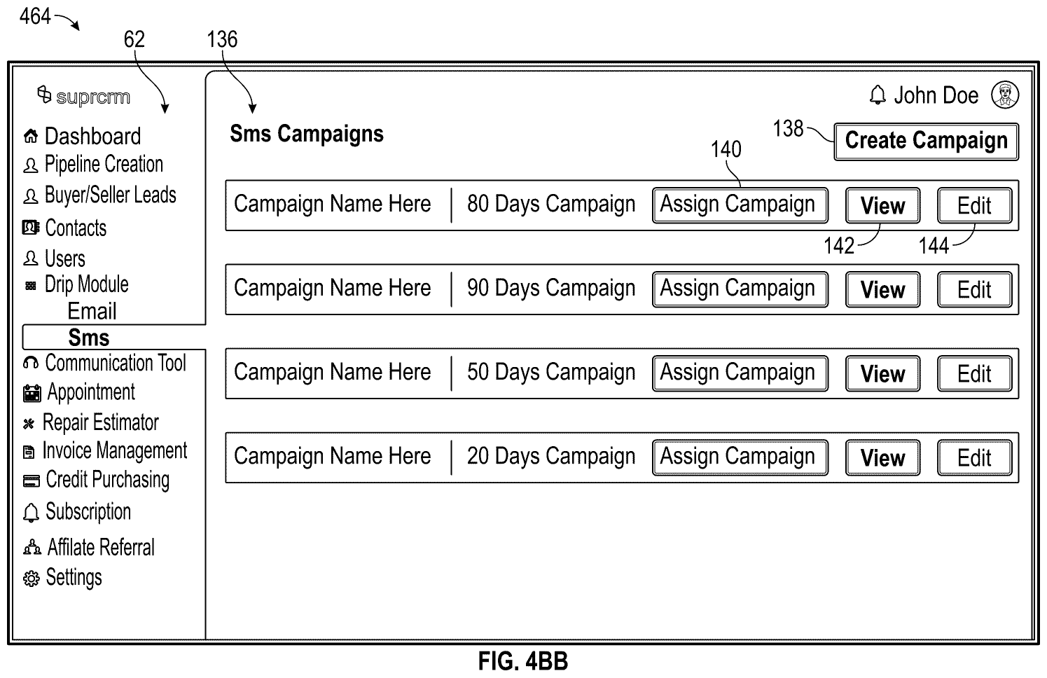

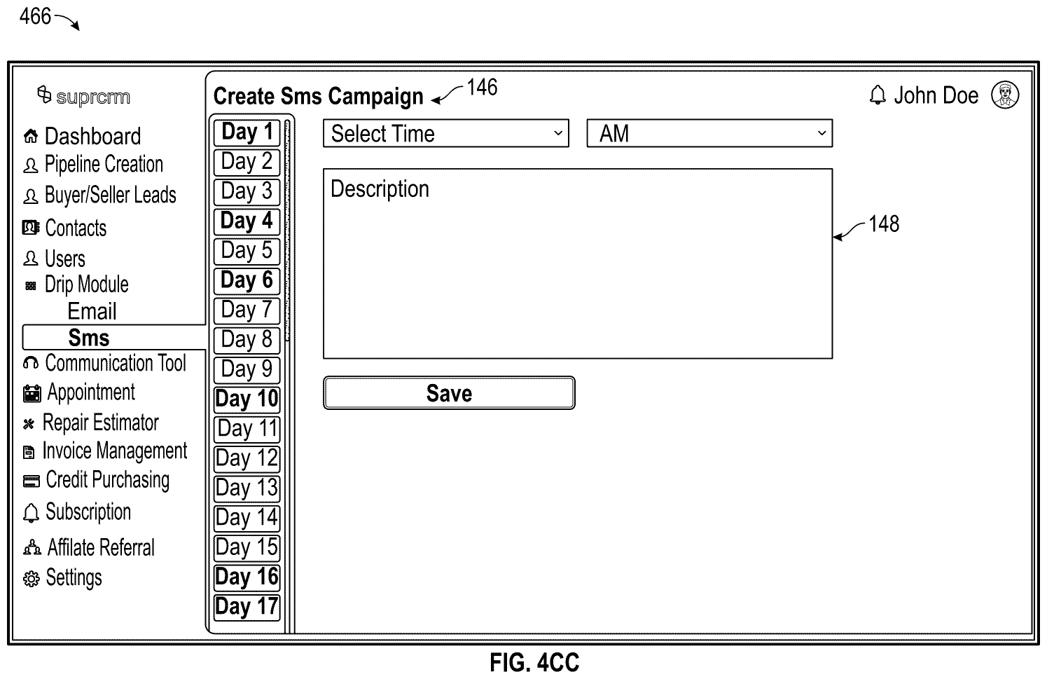

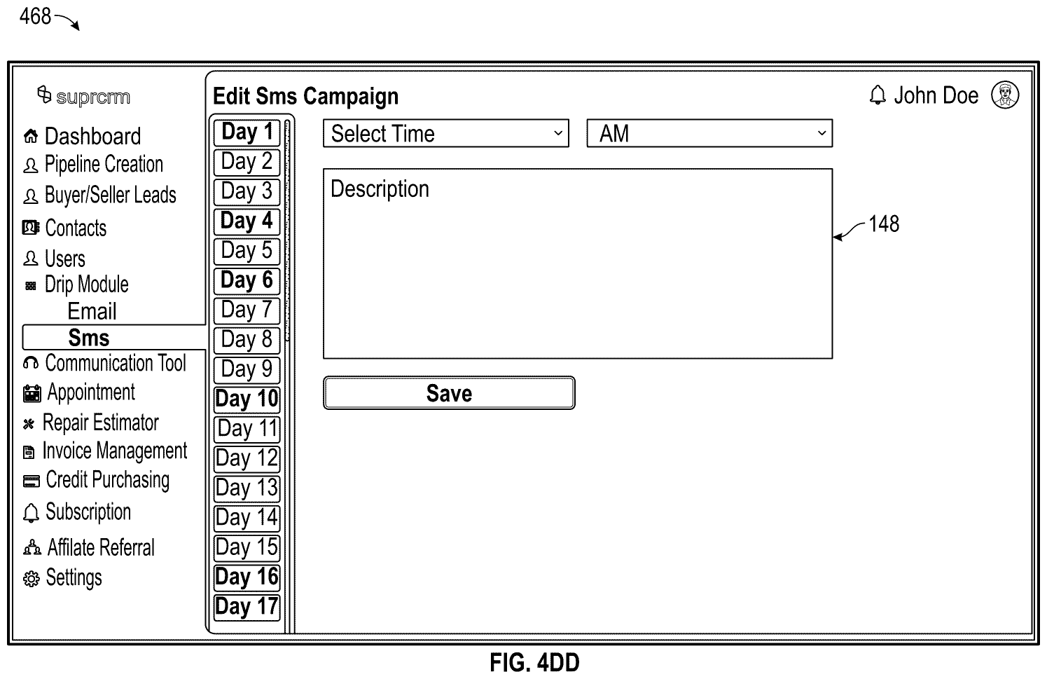

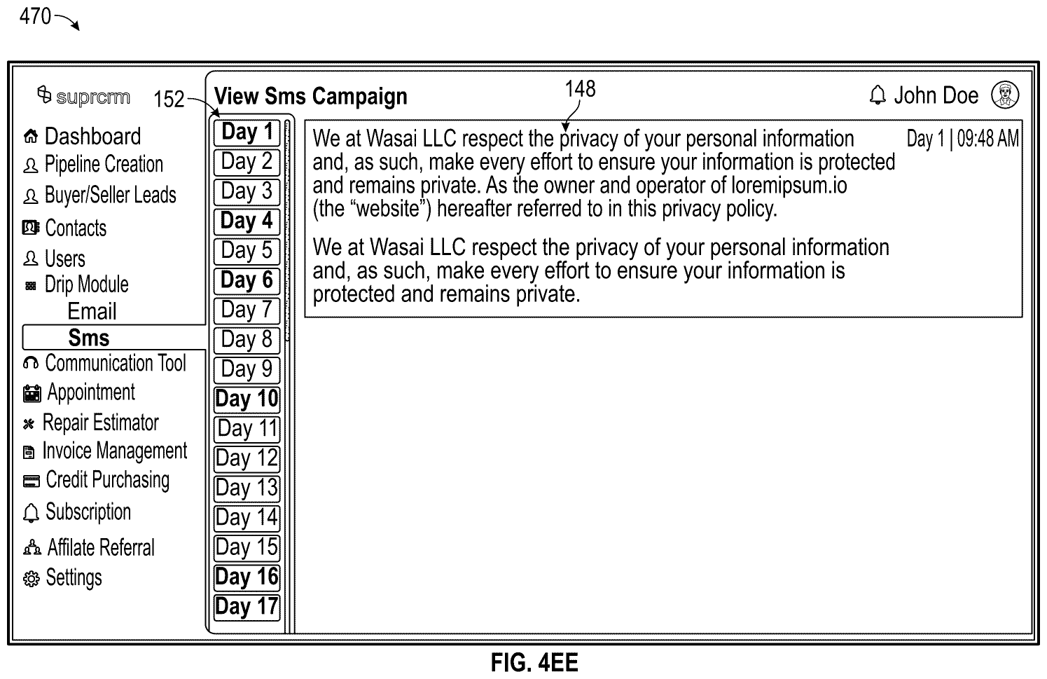

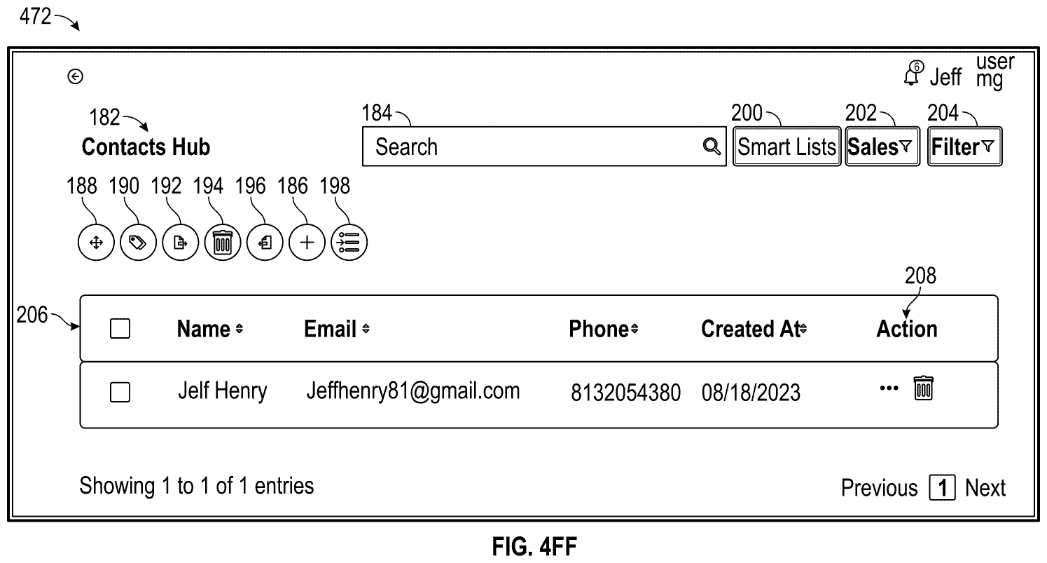

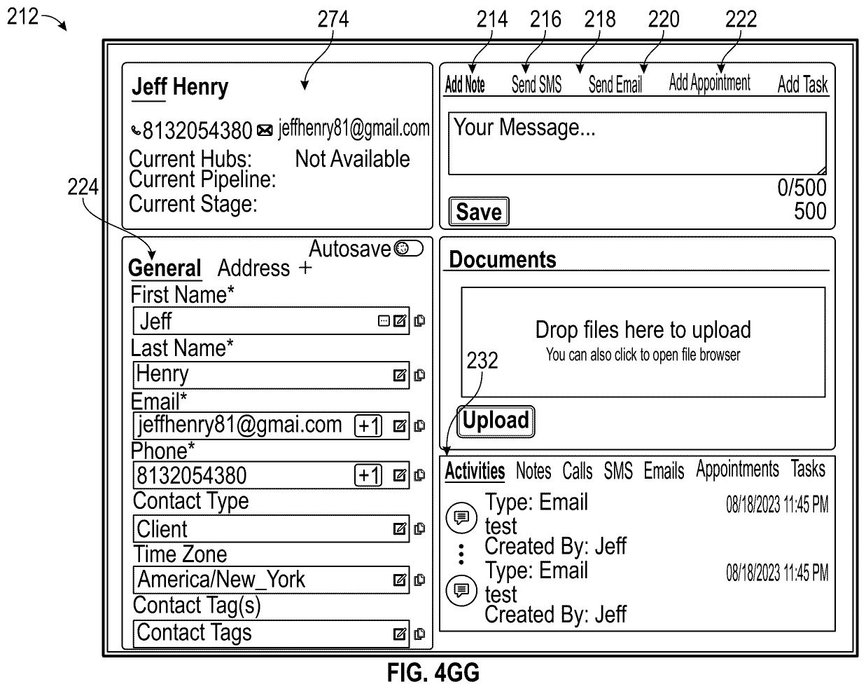

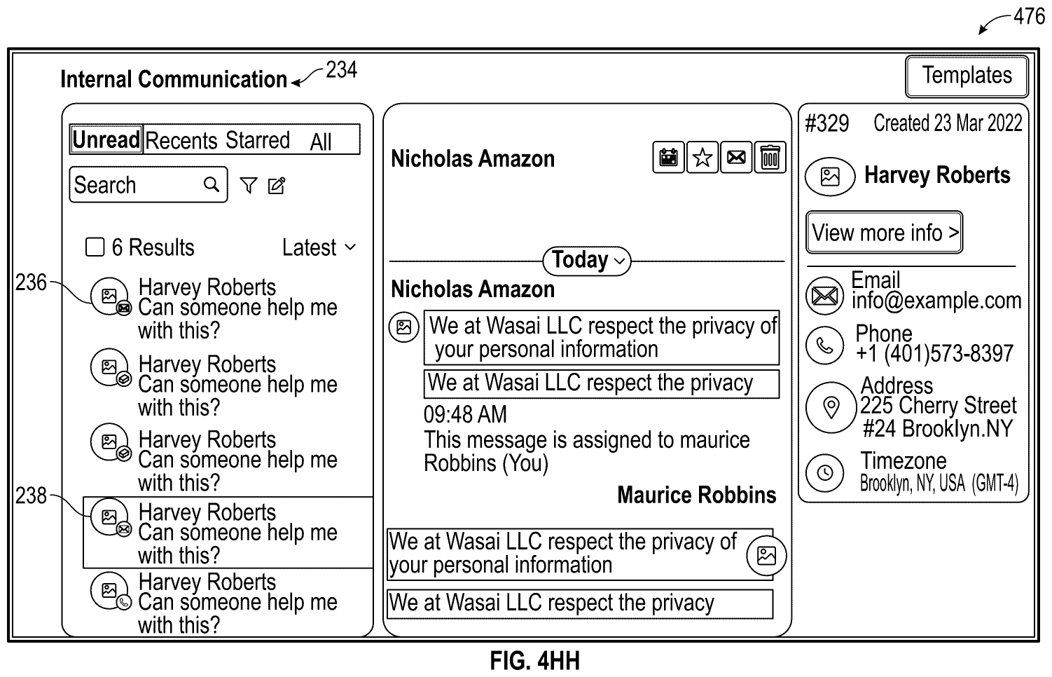

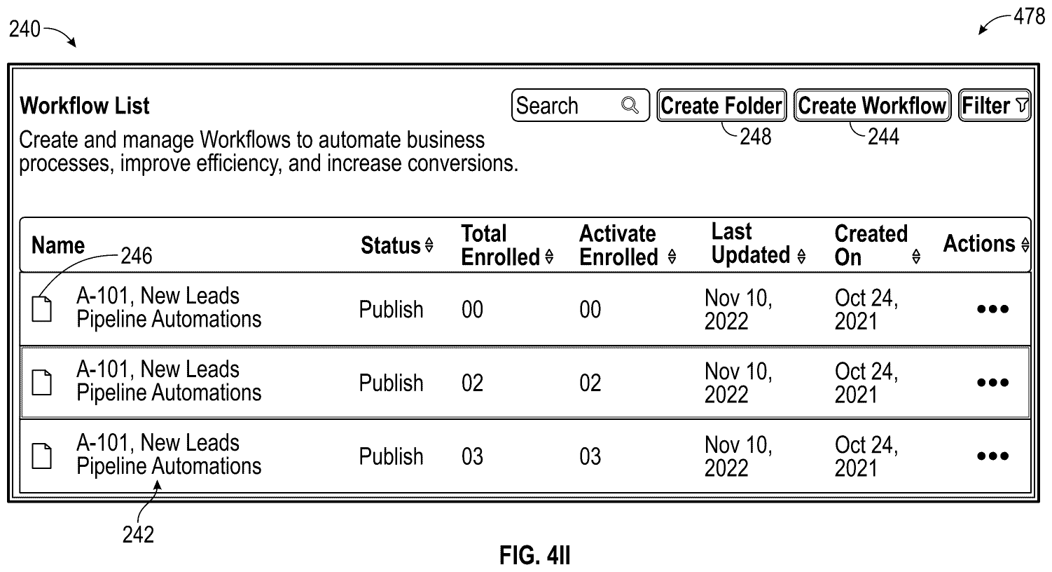

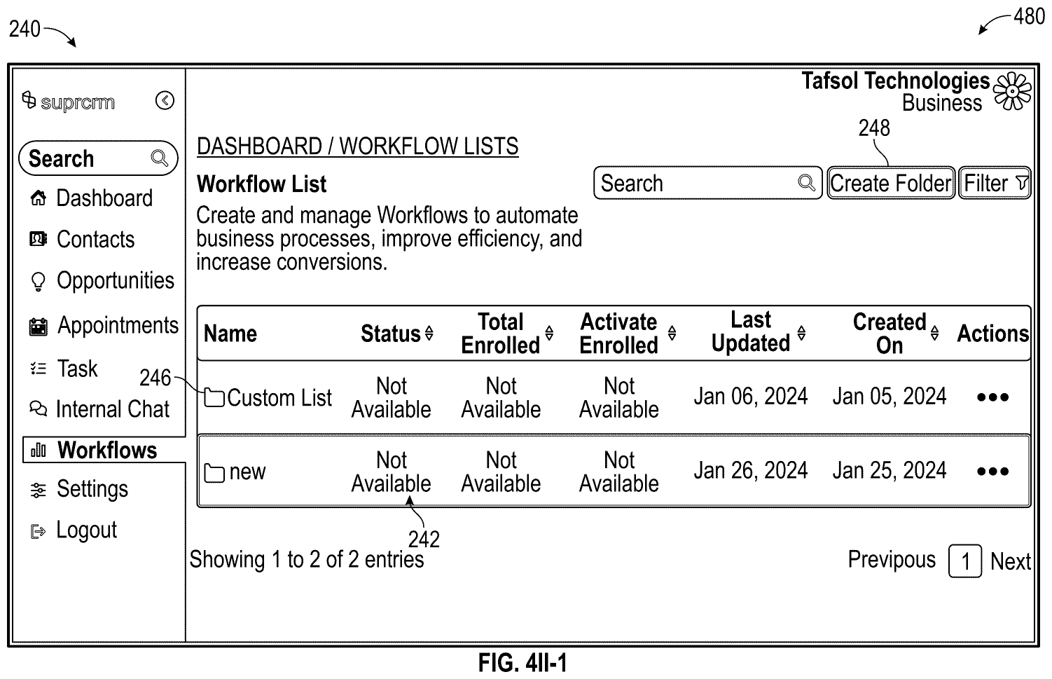

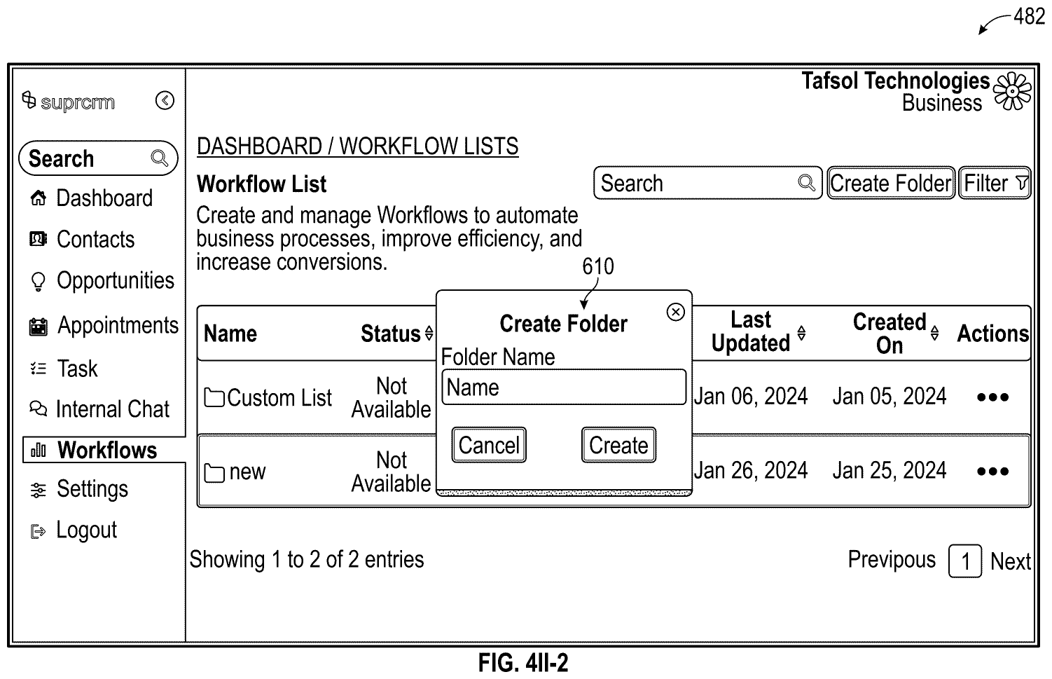

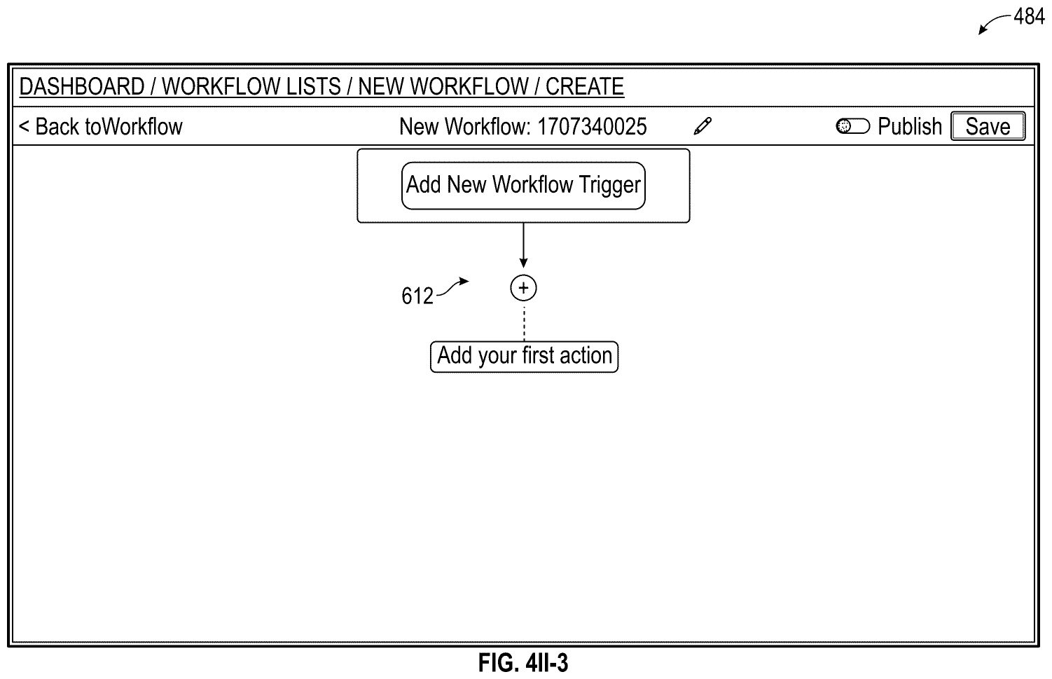

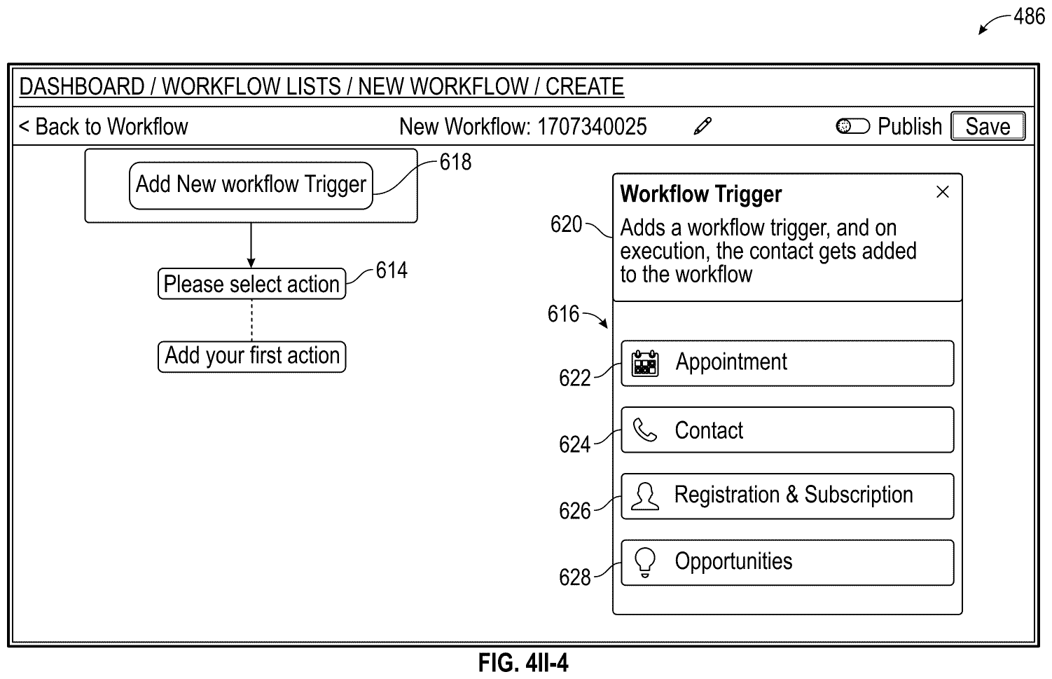

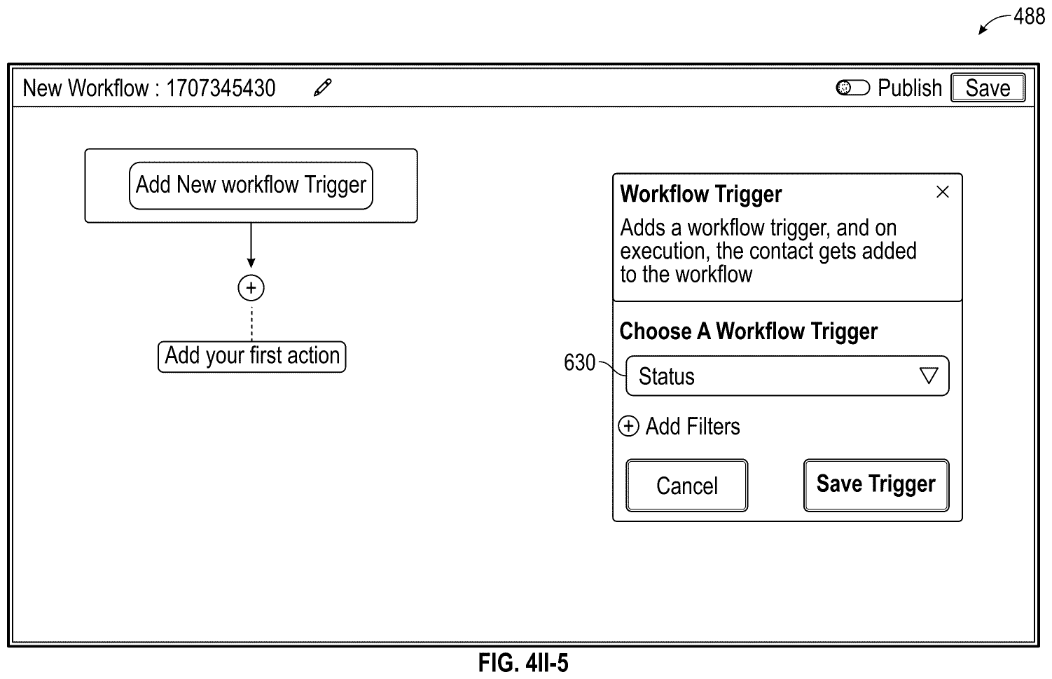

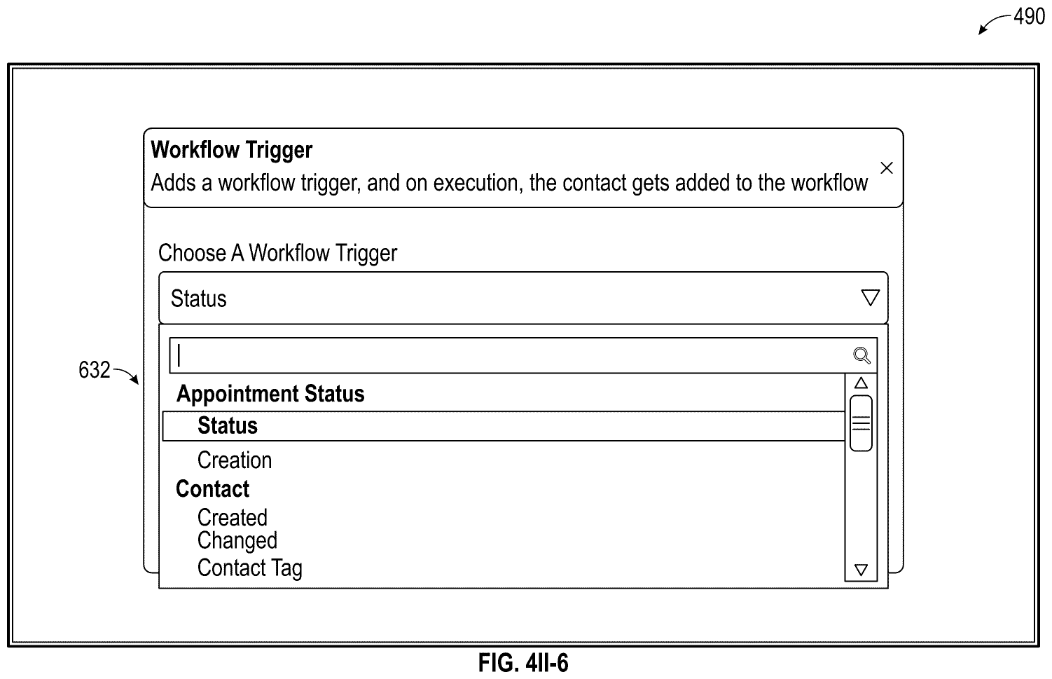

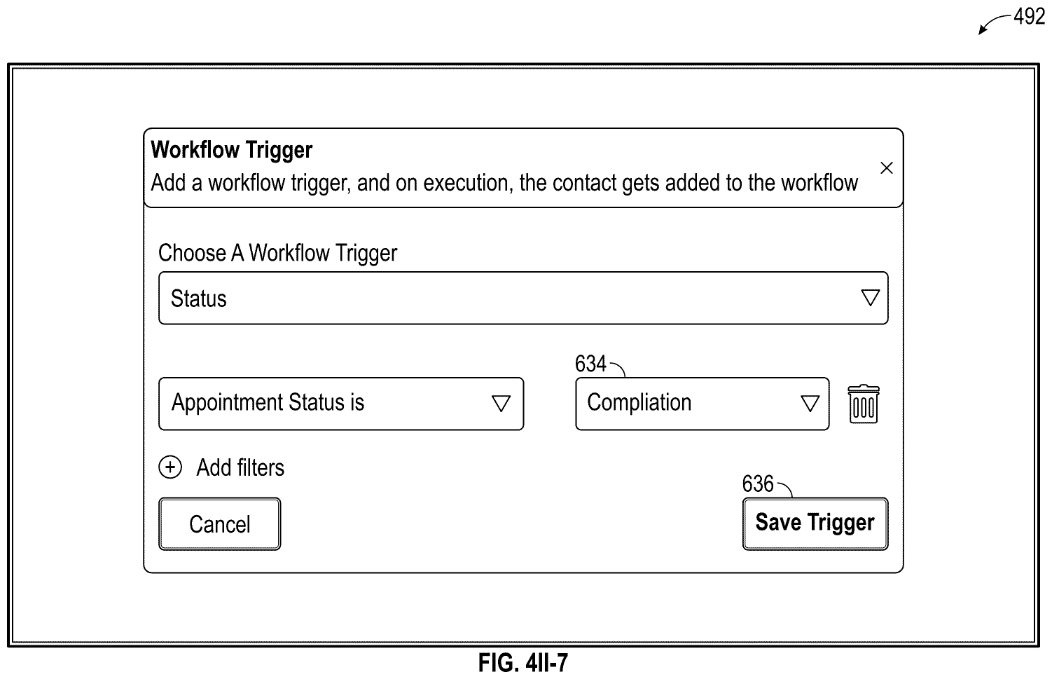

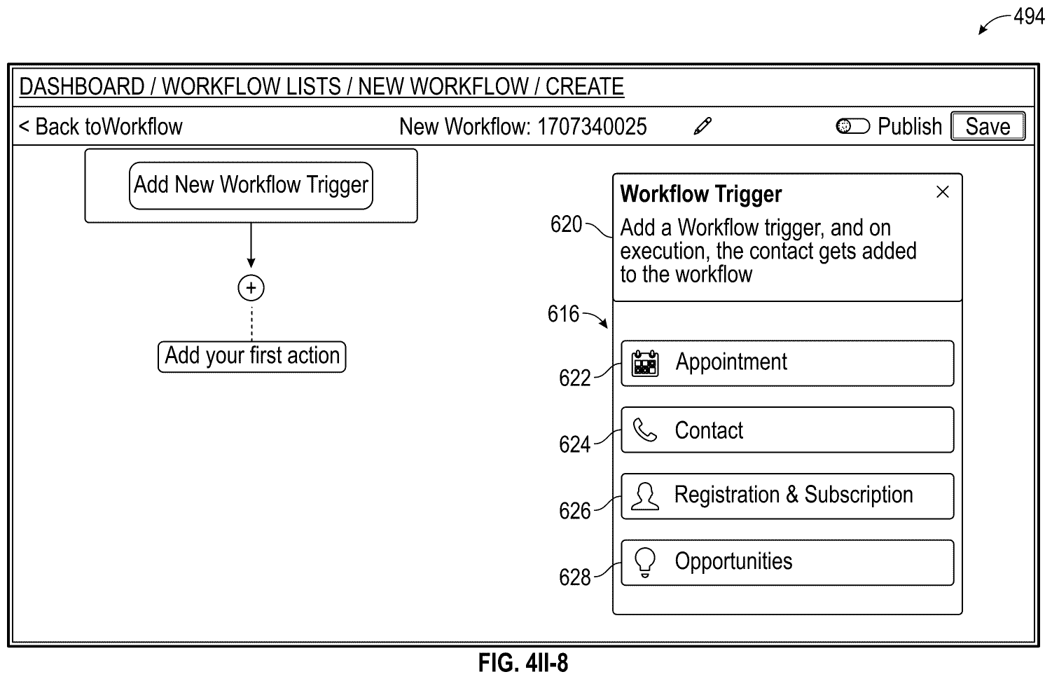

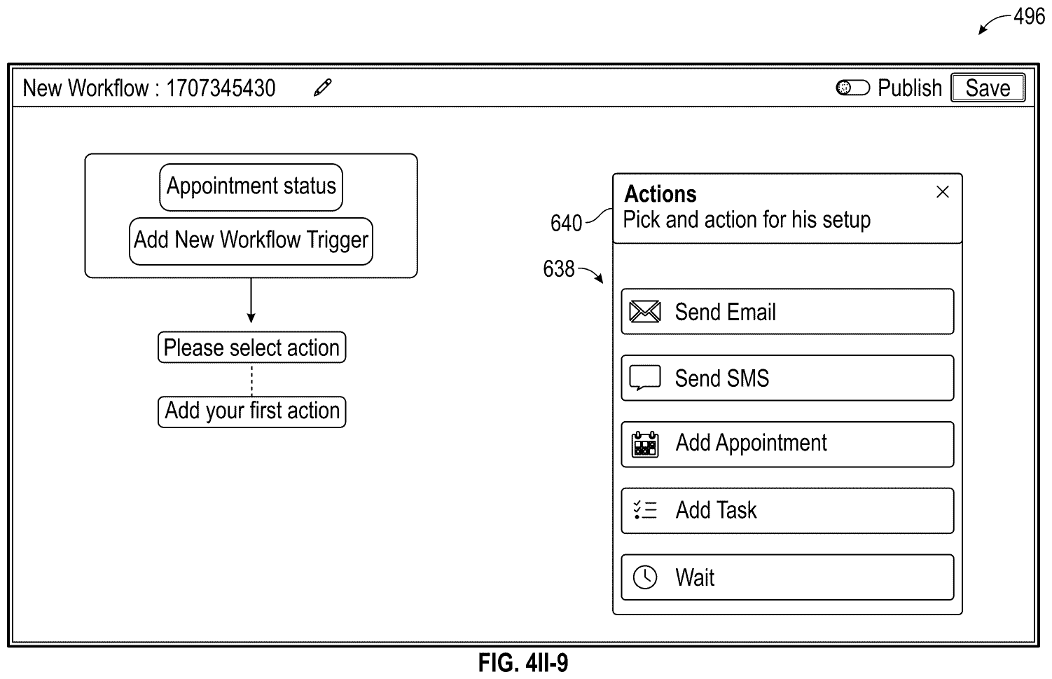

An example process will now be described with reference to FIGS. 4A-4CC illustrating example screenshots 410-474. FIG. 4A depicts the screenshot 410 of a graphical user interface (GUI) for allowing a user to log in with a user login credentials 66, such as user name and password, which can be displayed on the at least one computing device 12. The user can be an administrator of a company, for example. If the user forgets or enters the incorrect password, the user can enter his email address and a link will be sent to his email to reset the password. In certain aspects, the login process can include two-factor authentication with the user having the option to select whether the verification code is sent via email, SMS, and/or other appropriate communications. In such aspects, the user will receive the verification code and enter the verification code for the management service 10 or another service to verify the verification code and allow the user to log in.

If it is the user's first time logging in or have not set up a user profile, the screenshot 412, as depicted in FIG. 4B, of a GUI for allowing the user to enter general profile information 68 will be presented. The general profile information 68 can include, but is not limited to, logo, picture, business name, legal business name, business email, business phone, business website address, business niche, custom niche, and other appropriate information.

After the general profile information 68 is entered, the screenshot 414 of a GUI for allowing the user to enter business information 70 will be presented on the at least one computing device 12, as depicted in FIG. 4C. The business information 70 can include, but is not limited to, business type, business industry, business registration ID type, business registration number, business regions of operation, and other appropriate information. After the business information 70 is entered, the screenshot 416 of a GUI for allowing the user to enter a business physical address 72.

After the business physical address 72 is entered, the screenshot 418 of a GUI for allowing the user to enter authorized representative information 74 will be displayed on the at least one computing device 12, as depicted in FIG. 4E. The authorized representative information 74 can include information associated with an authorized representative of the company such as, but not limited to first name, last name, authorized representative email address, job position, phone number, and other appropriate information. With all the information entered and stored, the user will be presented with the screenshot 420 of a GUI for creating pipeline(s) 52, as depicted in FIG. 4F. The screenshot 420 of the GUI includes a create new pipeline button 78. In response to the user selecting the create new pipeline button 78, an add pipeline pop-up GUI 80 will be displayed to the user on the at least one computing device 12, as depicted in the screenshot 422 in FIG. 4G, for creating a new pipeline, such as the pipeline 52. The add pipeline pop-up GUI 80 is configured to allow the user to enter a pipeline name, add a stage, and save the created pipeline. Additionally, the user has options to display the pipeline 52 in the GUI dashboard as a funnel chart, a pie chart, both a funnel chart and a pie chart, and other appropriate visual representations. After the pipeline 52 is created, the user has the option to edit the pipeline 52, as depicted in the screenshot 424 illustrating an edit pipeline pop-up GUI 82 for allowing the user to edit a pipeline in FIG. 4H.

Furthermore, as depicted in FIG. 4I, a user can assign the status level 60 to the pipeline 52 based on the staged actions 54 being monitored, as illustrated in the screenshot 426 of a GUI for allowing a user to assign a status level 60 to the pipeline 52. The status level 60 can include, but is not limited to, open, won, lost, abandoned, and other appropriate status levels. For example, the user can select the add new status button 84 to add a new status such that a add status pop-up GUI 86 will pop up, as depicted in the screenshot 428 in FIG. 4J, so that the user can select the status level 60 from a drop-down box. Additionally, an existing status level can be edited when the user selects an edit status button 88 such that an edit status pop-up GUI 90, as depicted in the screenshot 430 in FIG. 4K, is displayed so that the user can edit the status level 60 from a drop-down box.

As illustrated in the screenshot 432 in FIG. 4L, the management app 46 is configured to display the entered information on the at least one computing device 12, such as the general profile information 68 that was entered and the business information 70 that was entered, so the user can review the entered information.

Referring to FIG. 4M, the screenshot 434 of a GUI for allowing the user to add a new opportunity(s) 92, which includes a first opportunity button 94, a first book/update appointment button 96, and a first opportunity task button 98, is displayed on the at least one computing device 12 by the management app 46. When the first opportunity button 94 is selected associated contact information 101 and opportunity information 102 can be entered or input via the GUI. The contact information 101 includes, but is not limited to, a contact name, an email address, a phone number, tags, a company name, and other appropriate information. The opportunity information 102 includes, but is not limited to, an opportunity name, a pipeline name, a stage, a status, a lead value, an owner name, an opportunity source, and other appropriate information. As depicted in the screenshot 436 in FIG. 4N, when the first book/update appointment button 96 is selected appointment information 104 can be entered via the GUI. The appointment information 104 includes, but is not limited to, a calendar date, a calendar name, a day of the appointment, a time of the appointment, a meeting location of the appointment, an appointment title, and other appropriate appointment information. As depicted in the screenshot 438 in FIG. 40, when the first opportunity task button 98 is selected opportunity task information 106 can be entered via the GUI. The opportunity task information 106 includes, but is not limited to, a task title, an assignment designation, a due date, a task description, and other appropriate information.

As depicted in the screenshot 440 in FIG. 4P, the contact information 101 and the opportunity information 102 can be edited via the GUI when the first opportunity button 94 is selected. As depicted in the screenshot 442 in FIG. 4Q, the appointment information 104 can be edited via the GUI when the first book/update appointment button 96 is selected. As depicted in the screenshot 442 in FIG. 4Q, the opportunity task information 106 can be edited via the GUI when the first opportunity task button 98 is selected.

Moreover, the management app 46 can display the dashboard GUI 62, as depicted in the screenshots 446 and 447 in FIGS. 4S1 and 4S2, respectively, so that the user can view the metrics 64 associated with at least the lead profiles 48 and the pipeline(s) 52. It should be understood that the management app 46 is configured to allow the dashboard GUI 62 to be customized by the user. The dashboard GUI 62 can be customized to display various charts, graphs, and representations of the metrics 64 in various layouts in order to present the metrics 64 in a convenient format according to preferences of the user. As non-limiting examples, the dashboard GUI 62 can display the number of “New Leads” and the percentage change of the number of “New Leads” from month to month; “Projected Profits” in monetary amount and the percentage change of the “Projected Profits” in monetary amount from month to month; “Closed Revenue” in monetary amount and the percentage change of the “Closed Revenue” in monetary amount from month to month; a breakdown of the pipeline(s) 52 by stages, percentages, and other appropriate breakdowns; a calendar 53 that can display a monthly calendar view with events that a clickable for further viewing of details; the tasks 58 in upcoming tasks view that are clickable for further viewing of details; recent activities 59 showing all recent activities (e.g., added new leads, messages, emails, SMS, tasks, calendar events, and other appropriate activities).

With reference to FIGS. 4S3 and 4S4, in certain aspects, the dashboard GUI 62 includes a collapsible menu bar 154. The collapsible menu bar 154 includes a full view, as depicted in FIG. 4S3, and a collapsed view, as depicted in FIG. 4S4. The collapsible menu bar 154 allows the user to point-and-click on icons to access specific functions, choose commands, perform tasks, check status, and other appropriate functions. For example, the collapsible menu bar 154 can include, but is not limited to, an arrow icon 156 that collapses the collapsible menu bar 154 when clicked and the collapsible menu bar 154 is in the full view such that only the icons of the collapsible menu bar 154 are displayed (the arrow icon 156 opens the collapsible menu bar 154 when clicked and the collapsible menu bar is in the collapsed view); a search box 158 that, when text is entered into, allows the user to search contact information 101 (e.g., contact Name, Email, Phone, Address, Company Name) that has been entered; a dashboard icon 160 that, when clicked, directs to the GUI dashboard 62; a contacts icon 162 that, when clicked, directs to a Contacts Hub page (see FIG. 4FF); an opportunities icon 164 that, when clicked, displays the pipelines 52 and opportunities 92 in the pipeline 52; an appointments icon 166 that, when clicked, displays the calendar 53 and appointment information 104; a tasks icon 168 that, when clicked, directs to a task manager to create tasks and display all tasks; an internal chat icon 170 that, when clicked, directs to an internal chat page (see FIG. 4HH) for allowing internal chats with team members; a reporting icon 172 that, when clicked, displays additional detail reporting that is not included on the main dashboard (e.g., the GUI dashboard 62); a workflow icon 174 that, when clicked, directs to a workflow page (see FIG. 4II) for allowing creation of unique workflows and automation for when new leads are added; a settings icon 176 that, when clicked, display settings associated with the management app 46; an account settings icon 178 that, when clicked, displays user settings; a logout icon 180 that, when clicked, logs the user out of the management app 46, and other appropriate icons.

As illustrated in the screenshot 448 in FIG. 4T, the management app 46 is configured to display an opportunities and pipeline GUI 108. The opportunities and pipeline GUI 108 allows the user to track and update the pipeline(s) 52 and the opportunities 92. For example, as illustrated in the screenshot 450 in FIG. 4U, the management app 46 is configured to display a view opportunity pop-up GUI 110, which includes an second opportunity button 112, a second book/update appointment button 114, and a second opportunity task button 116. When the first opportunity button 94 is selected, as shown in FIG. 4U, the contact information 101 and the opportunity information 102 associated with the selected opportunity is displayed. When the second book/update appointment button 114 is selected, as shown in the screenshot 452 in FIG. 4V, the appointment information 104 associated with the selected opportunity is displayed. When the second opportunity task button 116 is selected, as shown in the screenshot 454 in FIG. 4W, the opportunity task information 106 associated with the selected opportunity is displayed.

As illustrated in the screenshot 456 in FIG. 4X, the management app 46 can display an email campaign GUI 118 via the dashboard GUI 62. The email campaign GUI 118 includes a create email campaign button 120, an assign email campaign button 122, a view email campaign button 124, and an email campaign edit button 126. When the create email campaign button 120 is selected, as shown in the screenshot 458 in FIG. 4Y, a create email campaign GUI 128 is displayed such that the user can generate an email campaign 130 to send out. After the email campaign 130 has been created, it can be edited when the corresponding email campaign edit button 126 is selected, as illustrated in the screenshot 460 in FIG. 4Z. Moreover, when the view email campaign button 124 is selected, as illustrated in the screenshot 462 in FIG. 4AA, the email campaign 130 can be viewed via a view email campaign GUI 132, which is configured to display an email day tracker 134 so the user can observe progress of the email campaign in terms of days.

In a similar manner, as illustrated in the screenshot 464 in FIG. 4BB, the management app 46 can display an SMS campaign GUI 136 via the dashboard GUI 62. The SMS campaign GUI 136 includes a create SMS campaign button 138, an assign SMS campaign button 140, a view SMS campaign button 142, and a SMS campaign edit button 144. When the create SMS campaign button 138 is selected, as shown in the screenshot 466 in FIG. 4CC, a create SMS campaign GUI 146 is displayed such that the user can generate an SMS campaign 148 to send out. After the SMS campaign 148 has been created, it can be edited when the corresponding SMS campaign edit button 144 is selected, as illustrated in the screenshot 468 in FIG. 4DD. Moreover, when the view SMS campaign button 142 is selected, as illustrated in the screenshot 470 in FIG. 4EE, the SMS campaign 148 can be viewed via a view SMS campaign GUI 150, which is configured to display an SMS day tracker 152 so the user can observe progress of the SMS campaign in terms of days.

As illustrated in the screenshot 472 in FIG. 4FF, the management app 46 is configured to display a contacts hub GUI 182. The contacts hub GUI 182 displays some of the contact information 101 entered into the management app 46 and allows the user to point-and-click on icons to access specific functions, choose commands, perform tasks, check status, and other appropriate functions. For example, in certain aspects, the contacts hub GUI 182 includes, but is not limited to, a search box 184 that, when text is entered into, allows the user to search contacts that have been entered in the management app 46; a create contact icon 186 that, when clicked, opens a pop up window to create a new contact; an add to hub icon 188 that, when clicked, adds a selected contact to a specific hub; an add to tags icon 190 that, when clicked, add the selected tag to a specific contact; an export contacts icon 192 that, when clicked, exports the selected contacts to a CSV file; a delete contacts icon 194 that, when clicked, deletes the selected contacts from the database; an import contacts icon 196 that, when clicked, imports a CSV or other spreadsheet file into the management app 46; an add to smartlist icon 198 that, when clicked, adds the selected contact into a smartlist; a smartlist icon 200 that, when clicked, displays the smart lists and the number of contacts associated with each smartlist; a hub filter icon 202 that, when clicked, displays the different hubs that have been created; a filter icon 204 that, when clicked, filters the hubs by date, name, tag, and other appropriate information; a data table 206 that displays contacts by contact information 101 such as, for example, by name, email, phone, created on date, action, and other appropriate information such that the data table 206 can be sorted by ascending/descending order of the contact information 101; an action icon 208 that, when clicked, allows the user to choose an action function such as, but not limited to, view contact, edit contact, create task, create appointment, create opportunity, delete contact, and other appropriate functions.

As illustrated in the screenshot 474 in FIG. 4GG, the management app 46 is configured to display a contact details GUI 210. The contact details GUI 210 displays contact details 212 that can include, but is not limited to, full name, phone number, email address, current hubs, current pipeline, current stage, and other appropriate details. The contacts details GUI 210 is configured to display icons that, when clicked, perform functions. For example, the contacts details GUI 210 can include, but is not limited to, an add note icon 214 that, when clicked, allows the user to add text to a note and save it (the note can be timestamped and identify the user name); a send SMS icon 216 that, when clicked, allows the user to add an SMS and send it to the selected contact phone number (the SMS can be timestamped and identify the username as outgoing SMS); a send email icon 218 that, when clicked, allows the user to add an email and send it (the email can be timestamped and identify the user name as outgoing mail); an add appointment icon 220 that, when clicked, allows the user to create an appointment for this particular contact in the calendar 53; and an add task icon 222 that, when clicked, allows the user to create a task 58 in the task manager (the task 58 can be timestamped and identify the username as tasks set).

As illustrated in the screenshot 474 in FIG. 4GG, the contact details GUI 210 displays a contact field details 224, which displays all of the field and their folders that are created and will be stored including all major contact details. In certain aspects, an auto-save function can be selected to ensure that all changes will be automatically saved. If the user does not select the auto-save function, then an update button will need to be clicked in order to save updates to any of the fields. Each field of the contact field details 224 is associated with an edit button 226 that, when clicked, allows edits/updates to that field. Each field of the contact field details 224 is associated with a copy button 228 that, when clicked, copies the details/information in that field.

As illustrated in the screenshot 474 in FIG. 4GG, the contact details GUI 210 displays an upload section 230 that allows a user to click on an file icon and drop it into the upload section 230 for uploading the file to the database and associate the file with the particular contact. The contact details GUI 210 displays activities 232, which can be displayed by activity type.

As illustrated in the screenshot 476 in FIG. 4HH, the management app 46 is configured to display an internal communications GUI 234, which can display chats 236 and channels 238. The chats 236 and channels 238 can be sorted by unread, recent, starred, and all. The internal communications GUI 234 is configured to allow creation of channels 238 and private messages. The internal communications GUI 234 is configured to display communication threads (e.g., back and forth communications between users and/or team). The internal communications GUI 234 is configured to display contact details of team members who are communicating with the user.

As illustrated in the screenshot 478 in FIG. 4II, the management app 46 is configured to display a workflow list GUI 240. The workflow list GUI 240 is configured to allow creation of workflow 242 via create workflow button 244 and workflow folders 246 via create folder button 248. A list of workflow automations can be displayed by clicking on a workflow folder 246.

As illustrated in the screenshots 480 in FIGS. 4II-1 to 4II-10, an alternative workflow list GUI 240 can be displayed by the management app 46 in other aspects of the disclosure. The alternative workflow list GUI 240 depicted in FIGS. 4II-1 to 4III-10 differs from the screenshot 478 in that the creation of the workflow 242 is initiated in alternative manner as the create workflow button 244 is not displayed on the alternative workflow list GUI 240. After clicking on the create folder button 248, a create folder pop up window 610 is displayed to allow a user to enter a folder name and create a new folder of the workflow folders 246, as depicted in the screenshot 482 in FIG. 4II-2. After clicking on the created new folder of the workflow folders 246, a workflow list 612 is displayed listing the any created workflows such as workflow 242, as depicted in the screenshot 484 in FIG. 4II-3. To create an automation 614 to the workflow 242, a trigger 616 is set by clicking on the add trigger button 618, as depicted in the screenshot 486 in FIG. 4II-4. The trigger 616 can be selected from a list of triggers 620 of including, but not limited to, an appointment trigger 622, a contact trigger 624, a registration and subscription trigger 626, and an opportunities trigger 628.

As depicted in the screenshot 488 in FIG. 4II-5, the appointment trigger 622 was selected and now a trigger status 630 can be selected. The trigger status 630 can be selected from a trigger selection 632 including, but not limited to, status, creation, created, changed, contact tag, and other appropriate trigger statuses, as depicted in the screenshot 490 in FIG. 4II-6. Once the trigger status 630 is set, the trigger status 630 can be set to “compilation” 634 as depicted in the screenshot 492 in FIG. 4II-7. Then, the trigger status 630 can be saved by clicking on the save trigger status button 636. After the trigger status 630 is saved or set, the trigger 616 is selected from the list of triggers 620, as depicted in screenshot 494 in FIG. 4II-8. With the trigger 616 set, a trigger action 638 can be selected from a list of trigger actions 640 including, but not limited to, send email, send SMS, add appointment, add task, wait, and other appropriate trigger actions, as depicted in the screenshot 496 in FIG. 4II-9. The trigger action 638 sets the trigger 616 to perform the trigger action 638 (e.g., when appointment status is compilation, create a task). As depicted in the screenshot 498 in FIG. 4II-10, the trigger action 638 is performed, for example, such that a action dialog box 642 is displayed to complete the trigger action 638.

As depicted the screenshot 499 in FIG. 4JJ, after clicking on the create workflow button 244, the workflow 242 can optionally be created from predefined workflows or can be newly created from scratch. Creating a workflow 242 and automation can include, but is not limited to, creating a new contact, creating an appointment, creating a task, adding a pipeline, sending an email, sending an SMS, initiating a wait step, and other appropriate functions.

It should be understood from the above description that, in certain aspects, the management platform 32, the management app 46, or a combination of both is/are configured to: add, delete, and edit user profiles, admin profiles, and the lead profiles 48; manage all ongoing activities and tasks 58; manage account settings; create/send the user login credentials 66 to the associated organization/company via email by bypassing any subscriptions and can set the user login credentials 66; select active/inactive status of a user; create an organization/company profile and access all user's permissions; bypass existing/new user for making payments for a certain period; view the staff member's performance metrics; edit/update the authorized representative information 74; edit existing subscription packages; modify module permission within a subscription package; view subscription packages purchased by the organization/company; view invoices associated with the organization/company for the subscription package; receive money from the organization for the subscription package; customize the dashboard GUI 62 as well as the associated data/analytics for the dashboard GUI 62, such as the metrics 64; display analytics, reports, and/or the metrics 64 on the dashboard GUI 62 such as, but not limited to, sales performance, lead generation, lead statuses, customer support metrics, recent activity logs, drip sequence metrics, call metrics, SMS metrics; display the report statistics in various formats including, but not limited to, line charts, pie charts, bar charts, and other appropriate formats; generate reports against pre-defined options, such as, but not limited to, opportunities/pipeline structures, individual sales agents, organization/company reports, customer support metrics, and other appropriate options; create web/contact form for leads to fill out; select columns from templates in CSV files; display any of the above described information including but not limited to the contact information 101, the opportunity information 102, the appointment information 104, the opportunity task information 106, and other appropriate information; assign leads to staff members; create new users and assign a role and department to the new users within in the organization/company; create roles and assign permissions to the users to access and perform specific functionalities on the management platform 32; display stats and/or key performance indicators (KPIs) of customer support department of the organization/company; display list of staff members by department; display schedules; schedule appointments, for example, between staff and leads; sync third party calendar apps to the management platform 32; set dates for appointments; create the pipeline(s) 52 and assign different status to the pipeline(s); assign the pipeline(s) to a particular lead; modify statuses associated with the lead; monitor statuses of the lead and responsively generate staged actions 54 based on the status levels 60; create the email campaign(s) 130 and the SMS campaign(s) 148 based on the opportunity 92; transmit emails to the lead based on changes of the pipeline status; start/stop/resume the email campaign 130 and the SMS campaign 148; set the date and time when and for how many days to send the email campaign 130 and the SMS campaign 148 to the lead based on the pipeline status change; pause/stop the email campaign 130 and the SMS campaign 148 sequence; create a template for the email campaign 130 and the SMS campaign 148 for activities such as, but not limited to, login/signup, subscription payment, call reminder, an other appropriate activities; set the subject and content of the email campaign 130 and the SMS campaign 148; add template questions and answers associated with chatbot functionality; assign the email campaign 130 and the SMS campaign 148 to particular pipeline(s) 52; communicate for internal and external communication via AI chatbot, internal message system, third party SMS, and other appropriate communications; retrieve inquires via communications and assign the inquires to staff to answer; search for telephone numbers; communicate with leads; schedule calls; record calls; set voicemails; set call timeout; set whisper; transmit the SMS campaign via telephone numbers; manage the tasks 58 by, for example, Kanban board simulation; assign the tasks 58 to staff members; set statuses to indicate progress of the tasks 58; mark the tasks 58 status; assign lead to a staff member for appointment; create workflows to manage the tasks 58; generate billing invoices for subscriptions; display the invoice, which can include, but is not limited to, company name, current subscription plan, payment status, overall paid amount, payment date, next payment date, receipt, and other appropriate information; transmit/receive email for successful payment confirmation; transmit/receive the login credentials 66; transmit/receive notification of next payment date; provide purchase options for credits to send SMS and make calls; integrate with third party services and applications; track payments; and integrate with payment gateways.

Moreover, it should be understood from the above description that, in certain aspects, the management platform 32, the management app 46, or a combination of both is/are configured to include modules for providing features, such as, but not limited to: Navigation Links—Be easy to navigate, using quick links, etc.; Customizable—allowing the owner to edit the content, including text, images, fields, etc.; Subscription—a subscription-based model with three different plans for the client, allow the end users to upgrade/downgrade their subscription plan; Login System—allowing the client to log in to the system using the credential he/she receives on their email and log in with their email and password; Profile Management—Clients can manage their profile, email, password, Profile Photo, Name, phone number, Assign number, voicemail, hours of operation; Reporting Hub-allow clients to generate reports against the pre-defined options. (Lead Metrics, Pipeline stages Metrics, Call Metrics, Agent Metrics, SMS Metrics, Email Metrics, Drip Sequence Metrics); Custom Forms—The client can create unique forms to create inbound leads from either sellers or buyers; Pipeline Creation—Clients can create unique pipelines and add custom stages, these stages will have leads assigned to a particular stage; API integration-allowing the client to purchase multiple phone numbers and allowing the admin to assign to specific users and also add one as a primary to communicate with the leads; AI-Based Chat Module—Artificial Intelligence integration, allowing the client to set up predefined questions and their answers, fetch the client's queries and assign staff to cater to them appropriately; AI integration—allow users to create custom templates using Open AI, making it easier to generate SMS and email templates; Email & SMS Templates—Email & SMS Templates will be developed, allowing end users to create custom email & SMS templates that they can schedule with automation, one-off messages, and follow-up drip sequences; Notification System—when something happens, a notification will be added to the system to view. (new lead creation, new messages, upcoming tasks, overdue tasks, system updates, etc.); SMS Feature—Clients will send and receive SMS messages directly from their lead prospects. The clients will also be able to use templates that make SMS leads easier; Email Feature—Clients will send and receive Email messages directly from their lead prospects. The clients will also be able to use templates that make Email leads easier; Workflows—allow the admin to create automated flows; Drip Sequences—allow admins to create drip sequences for leads, inside the workflow automation area, there will be a section to create drips, which will enable the user to select (Email, Text, and Task) Templates, then they can set the number of days to send the following actions, time of day, etc.; SMTP Server—allowing the end users to connect their email account to send and receive emails directly into the system; Calling Feature—support calling directly inside the system, the end user can click on the call action button to contact directly to the client; Phone System—Clients can select phone numbers and add a friendly name, whisper message, enable call recording, add system timeout, etc.; Payment Gateway—integrated with a payment gateway (paddle.net), allowing the company to subscribe and select a package; Task Manager—a task manager, allowing users to create tasks on the Kanban board and assign it to other users. (task name, description, Status (Open, Close, Late), due date, Assign, single task, or recurring task options); User Permissions—The admin will be able to give user permissions and role permissions for each user. This will allow sections, reports, functions, etc to be hidden based on their roles and permissions; Teams-allows the admin to create custom teams, roles & responsibilities, user permissions etc. (Team name, Department, Add users); Calendars—a calendar and clients can add items (Name, Description, Start Date/Time, End Date/Time, Select Lead, Assign User) to the calendar for appointments, integration with third party calendars, so user can link their calendar to show conflicts to the calendar; Electric Contract Signing—Enable Esign contract signing for end users, the admins can add unlimited contracts to be selected, and they can map the fields to make it electronic for users; Billing System and Credits—Clients will have a billing section where they can track their invoices, update the credit card on file, view plans and upgrade/downgrade plans, See available credits, add more credits, view invoice pdfs, and export pdfs); Customer Support—This is a ticketing system where clients can submit support tickets to the system admins, and the support chat function, allowing the clients to chat directly with our support team. There will also have a knowledge base with information on all the different features (lead center, pipelines, Task Manager, Calendars, Internal Chat, Profile, Settings, Integrations), as well as idea submission area; Internal Chat—an internal team chat system where users can communicate with each other and have messages stored. Also be able to create chat channels, enable user roles, emojis search selection, gif search selection, chat history, and attach files; Affiliate Referral-integrate the first promoter into the system. All users will automatically get access and have a unique referral link they can use to send out to friends and family. There will be two tiers of affiliates, 1-25 clients signed up will receive 20% monthly commission, and users that are 25+ signups will receive 40% commission; API Key—Clients will have a standard API Key that will be auto-generated with the account setup but can also generate other API Keys to allow them to integrate with other SAAS Programs etc.; Webhook—Clients will be able to use webhooks to use for other 3-party software; Integrations—This is a section that will show clients what software we can integrate with; Global Search—A global search bar will allow users to find leads quickly (they can search by address, name, phone number, and email). Once they enter the info, results will start to populate to choose from; Contact Hub—This is a place where all contacts will be stored. In this area you have the ability to create different contact hubs (unlimited) along with being able to filter, have different views, export leads, view leads and bulk edit/delete actions. (Ex. Sales Hub, Recruitment Hub, Client Hub, etc.); Tags—Create unique tags with the ability to assign tags to contacts; Settings—Clients can manage everything else that is not in their profile including, but not limited to, Company Profile (Company Name, address, email, phone, logo, password), phone number, team management (add a team and assign user to a specific team), User management (add users (full name, email, phone), user roles (Regular user, light user, admin), User restrictions, Integrations (API. Webhooks, calendar integration, email integration, phone integration), custom sections, standard fields, and Custom Fields Builder (will have options like: radio button, check boxes, single line, multi line, address field, phone field, email field, Number Field, currency, calculation field (add, subtraction, division, multiple).

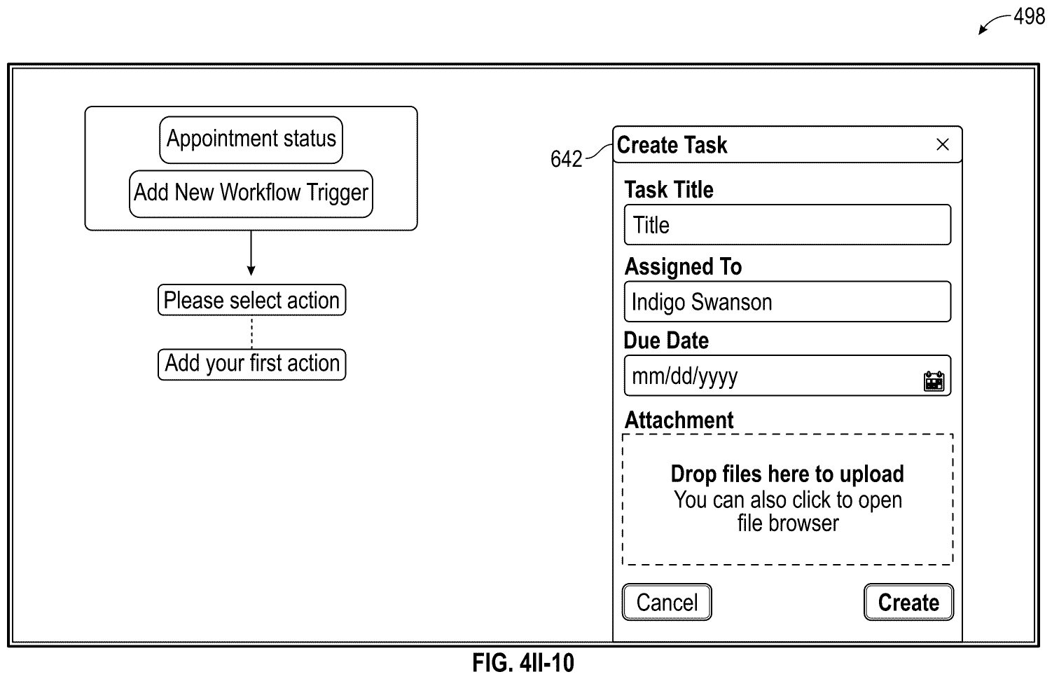

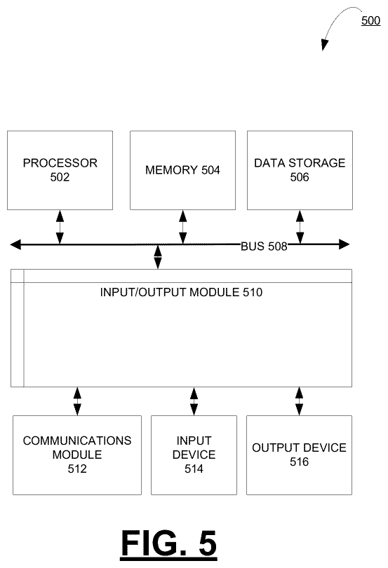

FIG. 5 is a block diagram illustrating an example computer system 500 with which management service 10, the at least one computing device 12, the at least one vendor service 14, and the database 16 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., the management service 10, the at least one computing device 12, the at least one vendor service 14, and the database 16) includes a bus 508 or other communication mechanism for communicating information, and a processor 502 (e.g., the processor 28, 34, 38, 42) coupled with bus 508 for processing information. According to one aspect, the computer system 500 can be a cloud computing server of an IaaS that is able to support PaaS and SaaS services.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., the memory 30, 36, 40, 44), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer readable medium for execution by, or to control the operation of, the computer system 500.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices (e.g., an input device, an output device). The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., the communications module 20, 22, 24, 26) include networking interface cards, such as Ethernet cards and modems.

In certain aspects, the input/output module 510 is configured to connect to a plurality of devices, such as an input device 514/or an output device 516. Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device.

According to one aspect of the present disclosure, the management service 10, the at least one computing device 12, the at least one vendor service 14, and the database 16 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for customizing data management based on database analytics, the method comprising:
creating lead profiles based on lead information;
generating a pipeline, wherein the pipeline comprises staged actions;
assigning a lead profile of the lead profiles created to the pipeline;
generating a campaign associated with the pipeline;
initiating tasks in response to status levels of the pipeline comprising the staged actions being monitored; and
customizing a graphical user interface dashboard for displaying metrics associated with the staged actions being monitored and based on the status levels of the pipeline comprising the staged actions.

2. The method of claim 1, further comprising receiving the lead information from inputted contact information and opportunity information.

3. The method of claim 1, further comprising displaying a collapsible menu bar via the graphical user interface dashboard comprising point-and-click icons, wherein an opportunities icon of the point-and-click icons, when clicked, displays the pipeline.

4. The method of claim 1, further comprising displaying an opportunities and pipeline graphical user interface configured to allow tracking and updating of the pipeline.

5. The method of claim 1, wherein generating a campaign associated with the pipeline further comprises creating, responsive to a selection, one of an email campaign and an SMS campaign.

6. The method of claim 1, further comprising displaying a contacts hub graphical user interface configured to export, when an export contacts icon of the contacts hub graphical user interface is clicked, selected contacts to a CSV file.

7. The method of claim 1, further comprising displaying a workflow list graphical user interface configured to allow creation of a workflow.

8. A system for customizing data management based on database analytics, the system comprising:
a memory comprising instructions; and
a processor configured to execute the instructions which, when executed, cause the processor to:
create lead profiles based on lead information;
generate a pipeline, wherein the pipeline comprises staged actions;
assign a lead profile of the lead profiles created to the pipeline;
generate a campaign associated with the pipeline;
initiate tasks in response to status levels of the pipeline comprising the staged actions being monitored; and
customize a graphical user interface dashboard for displaying metrics associated with the staged actions being monitored and based on the status levels of the pipeline comprising the staged actions.

9. The system of claim 8, wherein the processor is configured to execute the instructions which, when executed, cause the processor to:
receive the lead information from inputted contact information and opportunity information.

10. The system of claim 8, wherein the processor is configured to execute the instructions which, when executed, cause the processor to:
display a collapsible menu bar via the graphical user interface dashboard comprising point-and-click icons, wherein an opportunities icon of the point-and-click icons, when clicked, displays the pipeline.

11. The system of claim 8, wherein the processor is configured to execute the instructions which, when executed, cause the processor to:
display an opportunities and pipeline graphical user interface configured to allow tracking and updating of the pipeline.

12. The system of claim 8, wherein the instructions to generate a campaign associated with the pipeline which, when executed, further cause the processor to:
create, responsive to a selection, one of an email campaign and an SMS campaign.

13. The system of claim 8, wherein the processor is configured to execute the instructions which, when executed, cause the processor to:
display a contacts hub graphical user interface configured to export, when an export contacts icon of the contacts hub graphical user interface is clicked, selected contacts to a CSV file.

14. The system of claim 8, wherein the processor is configured to execute the instructions which, when executed, cause the processor to:
display a workflow list graphical user interface configured to allow creation of a workflow.

15. A non-transitory machine-readable storage medium comprising machine-readable instructions for causing a processor to execute a method for customizing data management based on database analytics, the method comprising:
creating lead profiles based on lead information;
generating a pipeline, wherein the pipeline comprises staged actions;
assigning a lead profile of the lead profiles created to the pipeline;
generating a campaign associated with the pipeline;
initiating tasks in response to status levels of the pipeline comprising the staged actions being monitored; and
customizing a graphical user interface dashboard for displaying metrics associated with the staged actions being monitored and based on the status levels of the pipeline comprising the staged actions.

16. The non-transitory machine-readable storage medium of claim 15, wherein the method comprises:
receiving the lead information from inputted contact information and opportunity information.

17. The non-transitory machine-readable storage medium of claim 15, wherein the method comprises:
displaying a collapsible menu bar via the graphical user interface dashboard comprising point-and-click icons, wherein an opportunities icon of the point-and-click icons, when clicked, displays the pipeline.

18. The non-transitory machine-readable storage medium of claim 15, wherein the method comprises:
displaying an opportunities and pipeline graphical user interface configured to allow tracking and updating of the pipeline.

19. The non-transitory machine-readable storage medium of claim 15, wherein the method comprises:
displaying a contacts hub graphical user interface configured to export, when an export contacts icon of the contacts hub graphical user interface is clicked, selected contacts to a CSV file.

15. on-transitory machine-readable storage medium of claim 15, wherein the method comprises:
displaying a workflow list graphical user interface configured to allow creation of a workflow.
